(19) United States
(12) Patent Application Publication
(10) Pub. No.: US 2026/0053705 A1
(43) Pub. Date: Feb. 26, 2026

(54) ACUPRESSURE DEVICES

(71) Applicant: Northwestern University, Evanston, IL (US)

(72) Inventors: Qian Wang, Evanston, IL (US); Bruce Livingston, Skokie, IL (US); Conor Edward Shanley, Emerald Hills, CA (US)

(21) Appl. No.: 19/106,555

(22) PCT Filed: May 11, 2023
(86) PCT No.: PCT/US2023/021902

§ 371 Date: Feb. 25, 2025

Related U.S. Application Data
(60) Provisional application No. 63/403,043, filed on Sep. 1, 2022.

(51) Int. Cl. A61H 39/04

(52) U.S. Cl. CPC A61H 39/04; A61H 2201/165; A61H 2201/1695

(57) ABSTRACT

An acupressure device includes a mount that is configured to attach to a patient and one or more indenter devices attached to the mount. An indenter device is mounted such that the indenter device is positioned over an acupuncture location of the patient. The indenter device has a base that contacts the mount and a tip that contacts the acupuncture location on the patient.

### CROSS-REFERENCE TO RELATED APPLICATION

The present application claims the priority benefit of U.S. Provisional Patent App. No. 63/403,043 filed on Sep. 1, 2022, the entire disclosure of which is incorporated by reference herein.

### BACKGROUND

Acupressure refers to a pain relieving technique that involves applying pressure to various locations of the body. The locations at which acupressure is applied are referred to as acupuncture locations, and are the same locations at which acupuncture therapy may be provided. Traditional acupressure is applied through hand massage, elbow massage, etc. Additionally, some devices are now available on the market which are purported to perform acupressure as a pain relief option.

### SUMMARY

An illustrative acupressure device includes a mount that is configured to attach to a patient and one or more indenter devices attached to the mount. The indenter device is mounted such that the indenter device is positioned over an acupuncture location of the patient. The indenter device has a base that contacts the mount and a tip that contacts the acupuncture location on the patient.

In one embodiment, the mount comprises one or more pieces of tape. In another embodiment, the mount comprises an adjustable strap. In one embodiment, the base of the indenter device includes a mount guide that is sized to receive the mount, where the mount guide includes sidewalls that extend from the base to prevent the mount from sliding off of the indenter device. In another embodiment, the indenter device has a cone shape such that the tip is pointed and causes a point contact at the acupuncture location. In an alternative embodiment, the indenter device has a triangular prism shape such that the tip forms a line and causes a line contact at the acupuncture location.

In one embodiment, the base of the indenter device includes one or more guide arms that control an angle at which the mount leaves the indenter device. In another embodiment, the base of the indenter device includes one or more annotations that indicate an optimal angle at which the mount is to leave the indenter device. In such an embodiment, the one or more annotations can include a first annotation that indicates a first optimal angle and a second annotation that indicates a second optimal angle, where the first optimal angle differs from the second optimal angle. In another embodiment, the base of the indenter device includes a first mount handle that is designed to receive a first portion of the mount and a second mount handle that is designed to receive a second portion of the mount. In one embodiment, the base of the indenter device includes a pivot arm that is designed to contact skin of the patient such that the pivot arm controls an angle of the indenter device relative to the skin of the patient.

In one embodiment, the tip of the indenter device is an electrode that is designed to deliver electrical stimulation to the acupuncture location. In another embodiment, the indenter device includes a pocket sized to receive a vibratory actuator, where the vibratory actuator causes vertical vibration of the tip of the indenter device. The pocket can also be sized to receive a battery to power the vibratory actuator, and the device can further include a power button mounted to the base of the indenter device, where the power button turns the vibratory actuator on and off.

In one embodiment, a heating element is mounted within the indenter device. The heating element heats the tip of the indenter device to deliver heat to the acupuncture location. Another embodiment includes one or more energy harvesters designed to provide power to the indenter device in response to movements of the patient. In one embodiment, the device includes a rod and a vibratory actuator mounted to a first end of the rod. A second end of the rod extends through a through hole in the indenter device such that the vibratory actuator causes horizontal vibration of the tip of the indenter device.

In one embodiment, the tip of the device includes a plurality of reservoirs that hold a chemical that is to be delivered to the acupuncture location. In another embodiment, the base of the indenter device comprises a frame, a motor mounted to the frame, and a linkage system that is connected to the motor. Activation of the motor activates the linkage system to cause the tip to roll across the acupuncture location. In another embodiment, the base comprises an extended curved base, and the extended curved base includes a pair of support wings that rest on skin of the patient. In one embodiment, the one or more indenters are configured for use on any location of the patient, including hands, feet, neck, back, legs, arms, head, or stomach. In another embodiment, the one or more indenters are mounted to a clamp that is sized to fit around a hand or a foot of the patient. In another embodiment, the mount comprises a face strap, and the one or more indenters are mounted to the face strap. The face strap can include an opening for a nose of the patient.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1 depicts a table that shows the full optimization problem formulation for the indenter device model in accordance with an illustrative embodiment.

FIG. 2 depicts a flow chart illustrating the entire two-stage optimization process for the proposed device in accordance with an illustrative embodiment.

FIG. 3 depicts an annotated image of an indentation loading fixture in accordance with an illustrative embodiment.

FIG. 4 depicts a median empirical displacement-force curve for the indentation device testing in accordance with an illustrative embodiment.

FIG. 5 shows an assembly of meshed components, revolved around the central axis of a two-dimensional axisymmetric FEM in accordance with an illustrative embodiment.

FIG. 6 is a table that depicts results of the DOE stage of optimization in accordance with an illustrative embodiment.

FIG. 7A is a table that depicts Bayesian Optimization with Gaussian Process modeling results in accordance with an illustrative embodiment.

FIG. 7B shows a table that summarizes the optimized material parameters of the Ogden material, the minimized error of the model, the number of iterations, and the total time of calculation in accordance with an illustrative embodiment.

FIG. 8 shows a plot of the optimized material displacement-force curve overlayed with the empirical data in accordance with an illustrative embodiment.

FIG. 9 shows a plot of the maximum, minimum and average nodal values of max principal strain in the deep muscle group as a function of indenter position in accordance with an illustrative embodiment.

FIG. 10 shows a plot of the maximum, minimum, and average nodal values of max principal strain in the deep muscle group as a function of indenter position for the finer range in accordance with an illustrative embodiment.

FIG. 11 shows a plot of the maximum, minimum, and average nodal values of max principal strain in the deep muscle group as a function of indenter angle across the coarse range in accordance with an illustrative embodiment.

FIG. 12 shows a plot of the maximum, minimum, and average nodal values of max principal strain in the deep muscle group as a function of indenter angle for the finer range in accordance with an illustrative embodiment.

FIG. 13 shows a side view of the indenter device attached to the neck in accordance with an illustrative embodiment.

FIG. 14 depicts conical indenter tip designs in accordance with an illustrative embodiment.

FIG. 15A depicts a single indenter secured to skin/muscle tissue with a mount in the form of a strip of tape in accordance with an illustrative embodiment.

FIG. 15B is a cross-sectional view that depicts use of a single indenter in a vertical orientation in accordance with an illustrative embodiment.

FIG. 15C is a cross-sectional view that depicts use of a single indenter at an angled orientation in accordance with an illustrative embodiment.

FIG. 16 depicts a comparison of a cone indenter to a line indenter in accordance with an illustrative embodiment.

FIG. 17A is a perspective view of a single indenter with a mount guide in accordance with an illustrative embodiment.

FIG. 17B is a side view of the single indenter with the mount guide in accordance with an illustrative embodiment.

FIG. 17C depict the single indenter with the mount guide mounted to a patient in accordance with an illustrative embodiment.

FIG. 18A depicts an indenter with a mount guide that is annotated with arrows to guide tape/strap application and result in a vertical orientation in accordance with an illustrative embodiment.

FIG. 18B depicts an indenter with a mount guide that is annotated with arrows to guide tape/strap application and result in an angled (or asymmetric) orientation in accordance with an illustrative embodiment.

FIG. 18C depicts the indenter of FIG. 18B mounted to a patient at the asymmetric (angled) orientation depicted by the guide arrows on the mount guide in accordance with an illustrative embodiment.

FIG. 19A is a perspective view of a single indenter with a base that includes mount handles in accordance with an illustrative embodiment.

FIG. 19B depicts the single indenter with the base that includes mount handles mounted to a patient in accordance with an illustrative embodiment.

FIG. 19C depicts how equal size tape segments attached to the mount handles results in a vertical load angle of the indenter in accordance with an illustrative embodiment.

FIG. 19D depicts how different size tape segments attached to the mount handles can be used to achieve an angled/asymmetric load angle in accordance with an illustrative embodiment.

FIG. 19E depicts an indenter with mounting tape in which adhesive has only been applied to certain selected areas of the tape (highlighted) to help control indenter orientation and effectiveness in accordance with an illustrative embodiment.

FIG. 20A depicts an indenter with a base having a pivot arm on one side and a mount handle on the other side in accordance with an illustrative embodiment.

FIG. 20B depicts the indenter with the pivot arm mounted such that the pivot arm is in contact with the skin and acts as a mounting guide to control indenter orientation in accordance with an illustrative embodiment.

FIG. 21A depicts an indenter mounted to a strap in accordance with an illustrative embodiment.

FIG. 21B depicts the indenter strap mounted to various locations on an arm of a patient in accordance with an illustrative embodiment.

FIG. 21C depicts the indenter strap mounted to various locations on a leg of a patient in accordance with an illustrative embodiment.

FIG. 22A is a bottom view of an indenter with a conductive electrode tip in accordance with an illustrative embodiment.

FIG. 22B is a cross-sectional view that shows the lead of the electrode inside of the indenter cone in accordance with an illustrative embodiment.

FIG. 22C depicts a pair of indenters with electrodes mounted to a patient and connected to an electrical stimulation machine in accordance with an illustrative embodiment.

FIG. 23A depicts a linear/vibratory actuator with power leads in accordance with an illustrative embodiment.

FIG. 23B depicts an indenter with a pocket to receive the linear/vibratory actuator in accordance with an illustrative embodiment.

FIG. 23C depicts the indenter with linear/vibratory actuator mounted to a patient to induce vibration in accordance with an illustrative embodiment.

FIG. 24 is an exploded view that depicts an indenter with a vibration actuator and an onboard battery in accordance with an illustrative embodiment.

FIG. 25 depicts an exploded view of an indenter with an incorporated heating element in accordance with an illustrative embodiment.

FIG. 26A depicts an energy harvester in the form of an unbalanced weight that spins on an arm and that is mounted to a user in accordance with an illustrative embodiment.

FIG. 26B depicts an energy harvester in the form of spinning weight that drives a spindle of an electromagnetic motor to generate back-EMF in accordance with an illustrative embodiment.

FIG. 27A shows an indenter with an attached miniature shaker in accordance with an illustrative embodiment.

FIG. 27B shows the indenter with attached miniature shaker mounted to a user in accordance with an illustrative embodiment.

FIG. 27C depicts a conical-cylindrical indenter with an attached miniature shaker in accordance with an illustrative embodiment.

FIG. 28A depicts a conical indenter with a vertical miniature shaker (i.e., vibrator) mounted to a base of the indenter in accordance with an illustrative embodiment.

FIG. 28B depicts a conical-cylindrical indenter with a vertical shaker and a horizontal shaker in accordance with an illustrative embodiment.

FIG. 28C depicts a conical indenter with horizontal vibration at an angled orientation in accordance with an illustrative embodiment.

FIG. 28D depicts a conical-cylindrical indenter with horizontal vibration at an angled orientation in accordance with an illustrative embodiment.

FIG. 28E depicts a conical-cylindrical indenter with both vertical and horizontal shakers to provide vibration at an angled orientation in accordance with an illustrative embodiment.

FIG. 29 depicts a solenoid incorporated into a cylindrical base of an indenter, along with inner workings of the solenoid in accordance with an illustrative embodiment.

FIG. 30A depicts a tip of the indenter coated with a therapeutic drug, ointment, or oil in accordance with an illustrative embodiment.

FIG. 30B depicts a tip with perforations to accommodate a therapeutic drug, ointment, or oil in accordance with an illustrative embodiment.

FIG. 30C depicts how the perforations in the indenter tip act as reservoirs to hold a chemical and release the chemical over time in accordance with an illustrative embodiment.

FIG. 31 depicts a double-indenter clamp in accordance with an illustrative embodiment.

FIG. 32A depicts a face strap with multiple indenters in accordance with an illustrative embodiment.

FIG. 32B is a plan view of the face strap mounted to a head of a user in accordance with an illustrative embodiment.

FIG. 33A depicts a kneading indenter in accordance with an illustrative embodiment.

FIG. 33B includes a series of images that depict the motion of the kneading indenter in accordance with an illustrative embodiment.

FIG. 34A depicts an indenter device with an extended base that is curved to match tissue curvature in accordance with an illustrative embodiment.

FIG. 34B depicts a top side of an indenter device that includes a base with support wings in accordance with an illustrative embodiment.

FIG. 34C depicts a bottom side of the indenter device with padding on the support wings of the base in accordance with an illustrative embodiment.

FIG. 34D depicts the indenter device with a curved, extended base mounted to a patient in accordance with an illustrative embodiment.

FIG. 34E depicts the indenter device having a base with support wings mounted to a patient in various locations along the spine in accordance with an illustrative embodiment.

FIG. 35A includes views of an indenter device that includes a plurality of indenters in accordance with an illustrative embodiment.

FIG. 35B depicts the multiple indenter device positioned on the posterior neck of a patient in accordance with an illustrative embodiment.

FIG. 36A includes views of an indenter device that includes a plurality of indenters to contact a plurality of trigger points in accordance with an illustrative embodiment.

FIG. 36B depicts the multiple indenter device positioned on a lower back of a patient in accordance with an illustrative embodiment.

FIG. 37A depicts a glove mount with interior indenters for treating a hand in accordance with an illustrative embodiment.

FIG. 37B is a side view of the glove mount and includes a sectional line in accordance with an illustrative embodiment.

FIG. 37C is a sectional view of the glove mount along the sectional line of FIG. 37B in accordance with an illustrative embodiment.

FIG. 38A depicts a foot mount with interior indenters for treating a foot in accordance with an illustrative embodiment.

FIG. 38B is a side view of the foot mount and includes a sectional line in accordance with an illustrative embodiment.

FIG. 38C is a sectional view of the foot mount along the sectional line of FIG. 38B in accordance with an illustrative embodiment.

### DETAILED DESCRIPTION

Myofascial pain syndrome (MPS) is a common musculoskeletal disorder that affects a large percentage of the U.S. population. MPS is characterized by focused spots in skeletal muscle, which are the sources of local and referred pain, known as trigger points. Trigger points may also cause reduced range of motion for the affected muscle. While there is insufficient evidence to identify a universal cause for trigger points and myofascial pain, research suggests that there are many causes that may contribute to its development, such as poor posture or activities that cause repetitive stresses to particular muscles or muscle groups. In addition to local and referred muscle pain and limited range of motion. MPS specifically in the head and neck region may also cause tinnitus, headaches, and jaw issues. The physical or chemical excitation of trigger-points is a method to release MPS.

Trigger points may be treated in several ways. Pharmaceutical (i.e., chemical) treatments include muscle relaxers and anti-inflammatory drugs, whereas non-pharmaceutical remedies include acupuncture, acupressure, massage, temperature treatments, etc. While many treatments aim to mitigate pain by reducing inflammation and promoting blood flow to the affected area, research has shown that applying manual pressure to physically stretch the muscle fibers in spasm in the trigger point is particularly effective. The Fascial Distortion Model (FDM) prescribes specific techniques of deep-tissue acupressure intervention, which have been shown to reduce pain intensity and improve the range of motion of the affected muscle groups.

In general, skeletal muscles contain special sets of intrafusal muscle fibers known as “muscle spindles,” which are attached to the spinal cord via motor neurons. Muscles spindles facilitate feedback to the central nervous system (CNS) related to the state of the muscle stretch, i.e., the state to which a muscle is contracted or elongated. When a muscle is stretched, the muscle spindle sends a signal to the CNS, informing the brain that the muscle is changing length. The brain responds by sending signals via motor neurons which tell the muscle fibers to contract and resist the motion. This phenomenon is known as the stretch reflex. In some instances, the stretch reflex signal may become over-excited. In this scenario, the CNS continually excites the motor neurons that tell muscles to contract, regardless of the feedback from the muscle spindle. This phenomenon is commonly referred to as muscle spasm, and can be caused by many factors, such as poor posture, overuse, physical injury, dehydration, electrolyte imbalance, etc.

Anatomically, a trigger point is in the form of a small node within the body of a larger skeletal muscle, in which a cluster of individual muscle fibers are stuck in spasm. Trigger point nodes are typically about 2-10 millimeters (mm) in diameter, and as such include multiple muscle fibers in spasm.

As discussed above, the application of physical pressure to a trigger point has shown to be an effective method of treatment. Pressure can help alleviate pain and heal the tissue in spasm by way of several mechanisms. First, stretching muscle fibers that are in spasm physically opposes the contractile motion of the muscles and instead, forces the muscles to elongate. It is important to note that the object of stretching should not be to present an equal and opposite force to elongate the fibers in spasm, as this may have an adverse effect and increase the overall muscle trauma. Instead, it is beneficial to apply a lower magnitude stretching force gradually, so as to encourage the muscles to relax without greatly increasing immediate muscle strain. The FDM techniques, for example, often apply manual palpitation over a period of 10-20 seconds until muscle release (or relaxation) is detected by the administering therapist.

Application of physical pressure to trigger points may have additional beneficial effects for both the root cause treatment and symptom management. Generally, muscles in spasm build up lactic acid, which is a byproduct of the anaerobic metabolic processes of the muscle cells. Lactic acid causes pain and soreness in the affected tissues. Pressure application can forcibly remove lactic acid from the cells of the affected muscles, which can alleviate pain and soreness. Distortion of the tissue created by physical pressure can also increase blood flow to the affected area, aiding in the recovery process. Finally, palpitation of the affected tissue can over-excite the muscle spindle reflex, causing the nerves in the muscle spindle to fatigue and cease to transmit signals, thereby forcing muscle relaxation. In summation, the treatment of trigger points with a physical pressure offers multiple simultaneous therapeutic benefits.

Treatments involving the use of physical pressure, such as FDM and acupressure therapy, have proven to be effective for trigger-point excitation. However, these forms of professionally administered physical therapy remain out of reach to many patients. Physical therapy is relatively expensive, and typically requires patients to travel to a medical office for treatment. Described herein is an inexpensive, but convenient alternative to professional services. More specifically, described herein is a medical device which applies pressure passively (i.e., without patient intervention or action after initial device setup), and may be used at home, without the supervision or aid of a medical professional.

Muscle pain may occur in any skeletal muscle and often in several common locations across the body. Skeletal muscles vary widely in size, shape, fiber orientation, and other attributes, meaning that the development of a single device for treatment of any trigger point in the body would be difficult. An alternative approach is to design devices for the treatment of specific muscle locations, corresponding to the most common muscle pain, which is in the neck. In addition to typical symptoms of the pain and reduced range of motion associated with neck pain, such pain can also lead to headaches, tinnitus, and jaw issues. For these reasons, one embodiment of the proposed device is focused on the muscle structures in the posterior neck. Alternative implementations can be used for other muscle groups, as described herein.

Trigger points in the posterior neck region commonly are in the deep layer of neck muscles, including the Longus capitis and the Longus colli, which run parallel to the spine and are critical to the articulation of the vertebrae in the neck. The deep layer is surrounded by several more superficial layers of muscle, including (in order from inner to outer muscles) the Semispinalis capitis, the Splenius capitis, and the trapezius. These muscle structures are surrounded by adipose tissue and skin. Application of a physical pressure for the treatment of trigger points in the deep neck muscles must therefore be transmitted through the skin, adipose tissue, and superficial muscle structures before reaching the target location of the treatment. Additionally, it is important to determine the optimal position and orientation to place an indentation device so as to maximize the therapeutic effect of the indenter on the muscles.

Several steps were taken to achieve the overall goal of determining the optimal indentation position and angle of the indentation device. First, empirical data was collected by performing indentation testing on the muscles of interest of volunteers. Overall tissue displacement as a function of applied static loading was recorded using a novel testing fixture. Next, a two-dimensional axisymmetric finite element model was constructed to simulate indentation of a soft material with a rigid indenter. The material properties of the elements in the simulation were obtained by minimizing the error between experimentally measured and finite element (FE) modeled using the Bayesian Optimization (BO) method, so that the simulated material behavior with the optimized material properties is nearly identically to the collected experimental data.

Once this optimized material model was generated, it was applied to a two-dimensional plane-strain finite element model geometrically accurate to a cross-section of the posterior neck. The deep muscles in the neck were partitioned from the rest of the tissue such that the strain in the deep muscle region could be isolated. Finally, indentation with a constant load and indenter tip geometry was performed numerically at various locations and pressure orientations on the geometrically accurate finite element model (FEM) to determine the optimal location and orientation of indentation for maximum principal strain in the deep muscle region of the model. This information was used to develop and prototype the indentation device described herein.

In an illustrative embodiment, a hyperelasticity model can be used to model indentation testing. The hyperelasticity model was selected over other models such as Hertzian models because of the rigid nature of the indenter as compared to the more flexible nature of human tissue. As discussed below, the hyperelasticity model was fitted to empirical data using an optimization technique. Several hyperelasticity models have been developed and used for modeling the mechanical response of human skin and muscle tissues. One of the most commonly used ones is the first-order Ogden hyperelastic solid model. Generally, the Ogden model is a constitutive equation relating the strain energy in a solid to the principal stretch ratios, given in Equation 1 below:

$$W = {\sum }_{i = 1}^{n} \frac{2 μ}{{α}^{2}} ( {λ}_{1}^{{α}_{i}} + {λ}_{2}^{{α}_{i}} + {λ}_{3}^{{a}_{i}} - 3 ) + K ( J - 1 - ln ( J ) ) . \qquad Equation 1$$

In Equation 1, W is the strain energy, n is the order of the model, λᵢ are the principal stretch ratios, μ is the initial shear modulus, α is the deviatoric exponent, K is a compressibility parameter, and/is the bulk modulus. For simplicity and for the fact of short-term pressure applications, the effect of viscoelasticity was assumed to be negligible, and various tissues in the posterior neck were also considered to be incompressible. Because of these assumptions, a simple first-order Ogden model is feasible. Equation 2 reflects such a simplified form of Equation (1) based on these assumptions.

$$W = \frac{2 μ}{{α}^{2}} ( {λ}_{1}^{a} + {λ}_{2}^{α} + {λ}_{3}^{α} - 3 ) . \qquad Equation 2$$

In order to use the simplified first-order Ogden model expressed in equation 2, it was also assumed that the tissue behaved as a single homogeneous isotropic solid. As discussed, the tissue structures that make up the posterior neck are not homogeneous or isotropic: rather, they are comprised of many layers of muscle with differing fiber directions, adipose tissue, connective tissue, and skin. However, testing data was gathered from in vivo test subjects, which restricted the ability to isolate specific tissues for independent testing. Instead, the Ogden model created in this work was considered to be an equivalent homogeneous isotropic material to the collection of heterogeneous anisotropic tissues in the posterior neck. The equivalent Ogden material was optimized such that its displacement-force behavior was virtually identical to empirically collected data. Optimization processes are discussed in further detail below.

Two FEM models were developed, and they were constructed from two-dimensional elements. The first model was constructed from axisymmetric elements to simulate simple axisymmetric indentation, for the purposes of optimizing the material behavior to effectively simulate empirical data. The second model was constructed from plane strain elements for the purposes of determining the relative difference in maximum principal strain in the deep muscle group for different indentation locations and orientations. Both models were constructed in Abaqus/CAE, and calculated using the implicit solver.

Axisymmetric elements (CAX4) assume that the stresses and strains of elements in the cross-section of a revolved body are equivalent for any axisymmetric cross-sectional plane. Since the material model optimization FEM is modeling an axisymmetric load for the purposes of optimizing Ogden material parameters, the CAX4 elements were an appropriate choice. Plane strain elements (CPE4) assume that the out-of-plane strain (i.e., ε₃₃) is zero. The indentation of trigger points as simulated in the plane strain model therefore assumes that the out-of-plane direction is a thick structure, or that the indentation behavior is approximating line contact. This is not necessarily the case for trigger point treatment, where the trigger point nodes are generally circular. However, within the scope of this work, the plane strain model was considered to be a sufficient approximation of the behavior of the equivalent neck muscle material cross section.

The axisymmetric and plane strain approximations were made for the sake of computational efficiency. Reducing the simulation from three dimensions to two dimensions decreases the number of degrees of freedom from six to three, while also drastically reducing the number of elements in the model. Since soft contact models necessarily exhibit large deformations, relatively fine meshes and small step sizes are used to ensure model convergence. For reasonably accurate solutions, a two-dimensional model may take approximately two minutes to run on an ordinary workstation, but equivalent three-dimensional simulations may take dozens of hours. Furthermore, the FEM analyses are run many times in succession for optimization of the model parameters, and it is therefore crucial to keep simulation length to a minimum when several dozen optimization iterations are being run.

The axisymmetric FEM was generated as a tool for determining the optimal parameters α and μ of the first-order Ogden hyperelastic solid (see Equation 2). The optimized material parameters α* and μ* were used in the plane strain FEM to determine the optimal position and orientation of indentation for maximum therapeutic effect. The process for determining α* and μ* involved a quantification of the error between empirical data and data generated from the axisymmetric FEM. In empirical testing, tissue displacement was recorded as a function of applied static loading conditions, giving the empirical relationship δₑₘₚ=f(Fₑₘₚ), where δₑₘₚ is the empirical displacement of tissue, and Fₑₘₚ is the static load applied causing each displacement. Similar data was recorded during FEM simulations. Specifically, the axisymmetric model was statically loaded in increasing increments, and the resulting simulated displacement was recorded for each load increment, resulting in an analogous relationship δ_{FEM}=f(F_{FEM}), where δ_{FEM} is the simulated displacement, and F_{FEM} is the corresponding load. The error e between the two was quantified as the sum of squared errors, described by Equation 3:

$$e = \int {[ {δ}_{FEM} ( F ) - {δ}_{emp} ( F ) ]}^{2} dF . \qquad Equation 3$$

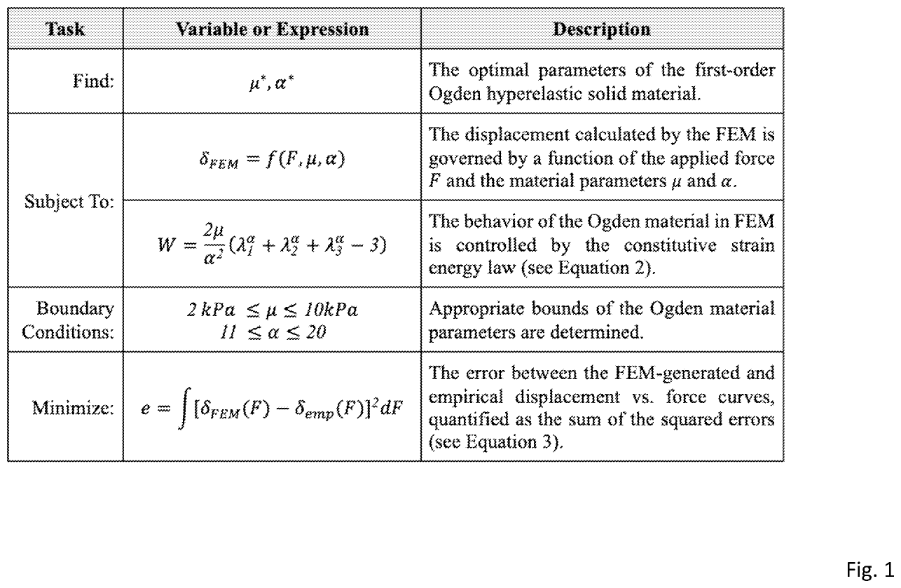

The error relationship described by Equation 3 was used as the objective function of the optimization problem formulation. Bounds for the design variables α and μ were also determined. FIG. 1 depicts a table that shows the full optimization problem formulation for the indenter device model in accordance with an illustrative embodiment.

The structure of the optimization process includes two stages: a Design of Experiments (DOE) stage and a Bayesian Optimization (BO) stage. This general optimization structure was applied to the Ogden material simulation to determine the optimized material parameters. Optimization was performed primarily using the Simulia Isight software package, implementing Abaqus, Data Matching, and MATLAB modules for specific tasks. In alternative implementations, different software can be used.

The general structure of the optimization process is outlined as follows. First, DOE methods are used to create an initial dataset for later optimization routines. The DOE method selects 16 combinations of starting parameters αᵢ and μᵢ (within the boundary conditions) using an Optimal Latin Hypercube Sampling technique (OLHS). For each of the 16 combinations of parameters, the displacement at regular increments of force is computed using the Abaqus FEM module. Next, the displacement-force data collected from the FEM module is compared to the empirical data, and a Data Matching module is used to compute the sum of squared errors between the simulated and empirical data, per Equation 3. Once the error corresponding to each of the OLHS-selected starting design variable combinations is calculated, the design variable combinations and corresponding errors are collected into an initial matrix DO for use in the next stage.

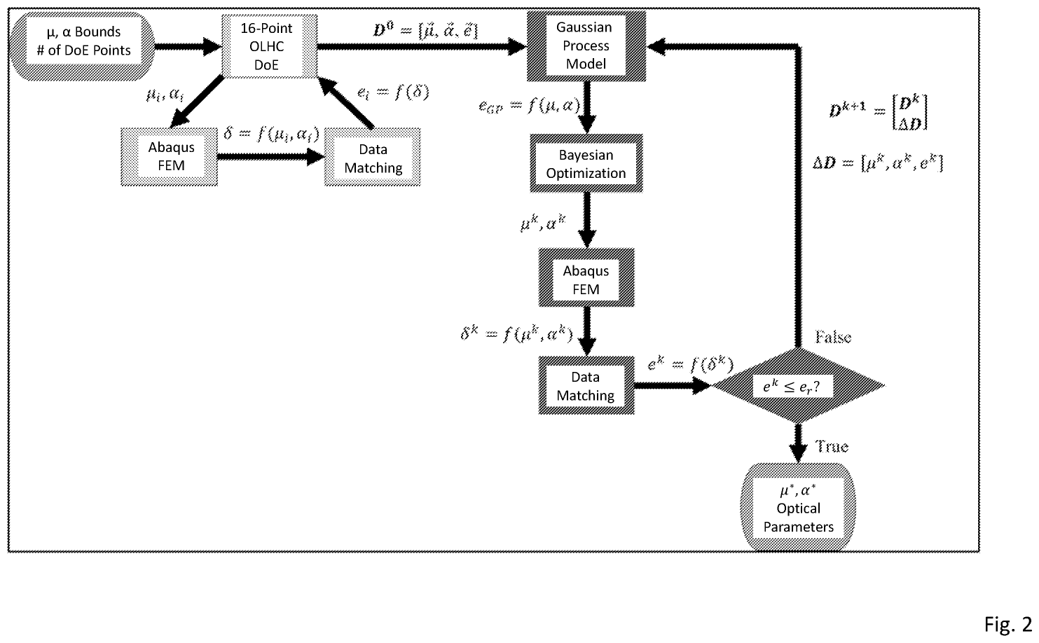

After constructing the initial matrix D⁰ using DOE techniques and OHLS, BO is performed to determine the optimal design variables α* and μ* for minimized error between empirical and simulated displacement-force data. FIG. 2 depicts a flow chart illustrating the entire two-stage optimization process for the proposed device in accordance with an illustrative embodiment.

The initial matrix DO was used to construct a Gaussian Process (GP) model, which creates a continuous error function e_{GP}=f(μ, α) based on the set of discrete data points given by D⁰. The BO process generates a set of uniformly distributed test values for the design variables within the boundary conditions listed in the table of FIG. 1. An acquisition function determines which of the specific test parameters, μ⁰ and α⁰, correspond to the maximum expected improvement to the value of the objective function. In other words, μ⁰ and α⁰ are the values most likely to result in a new minimum error value (smaller than the current lowest error value), based on the expected value of the GP model. To test the predicted point of maximum improvement, the selected parameters μ⁰ and α⁰ were sent to the Abaqus module, which computes the displacement-force curve. This data was sent to the Data Matching module, which computes the true error, e⁰.

The true error value was compared to an error threshold value e_{T}. If the true error is below the threshold, the optimization loop terminates, and (e⁰, μ⁰, α⁰) is selected as the optimal point. However, if the true model error e⁰ is greater than the error threshold e_{T}, the result of this iteration (e⁰, μ⁰, α⁰) is concatenated with the original GP input matrix D⁰, incrementing to D¹. The loop repeats, calculating a new GP model with an extra datapoint, which causes the BO process to make a new selection for the optimal point based on this updated model. This optimization loop is iterated until the error threshold is reached.

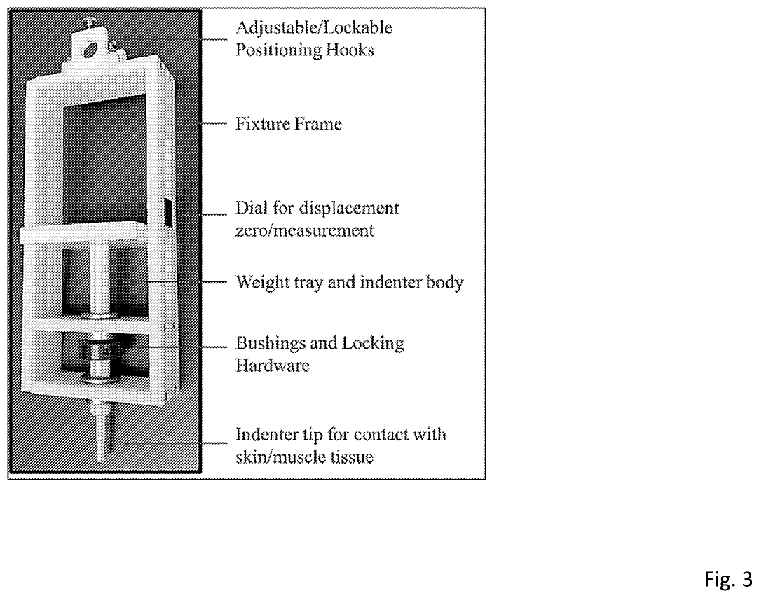

Empirical testing was also performed. The proposed device is primarily concerned with the mechanical behaviors of in vivo human tissue structures in the posterior neck for the treatment of trigger points. As such, empirical data was collected from volunteers using a custom minimally-invasive indentation loading fixture and testing apparatus. FIG. 3 depicts an annotated image of an indentation loading fixture in accordance with an illustrative embodiment. As shown, the fixture (or device) includes adjustable/lockable positioning hooks, a fixture frame, a dial for displacement zero/measurement, a weight tray and indenter body, bushings and locking hardware, and an indenter tip for contact with the skin/muscle tissue. In an alternative embodiment, the device can include fewer, additional, and/or different components.

Referring to FIG. 3, the loading fixture included a 4 mm diameter indenting tip fastened to a weight tray, and held in place by a frame with a set of parallel bushings. The indenter tip and weight tray were allowed to slide freely along a fixed linear track. A shaft collar was attached to the body of the indenter to allow the position of the weight tray to be locked in place. The frame also contained a sliding dial on one side, which can be locked in place with a thumbscrew. Two adjustable mounting hooks were affixed to the top of the frame to position the loading fixture. In the testing apparatus, the fixture pictured in FIG. 3 was suspended from a ring stand, which was rigidly affixed to a lab bench. The fixture was suspended over a massage table for volunteer testing.

During a typical test, a volunteer was asked to lay in a prone position on the massage table with his/her hands at their sides. A face cradle was used to support the volunteer's head and neck in a relaxed neutral position. The volunteer was allowed to relax for several minutes to ensure transient muscle tightness from getting into testing position had subsided. Once the volunteer was fully relaxed, the indentation testing fixture was positioned over the posterior neck on the volunteer's dominant side. Indentation testing was performed in three locations approximately 1 inch lateral to the centerline of the spine on the dominant side, adjacent to the spinous process of cervical vertebrae C3, C5, and C7. At each location, the indenter was locked in place and positioned directly above the contact point. The thumbscrew dial on the side of the fixture frame was locked in place, contacting the top of the weight tray, effectively zeroing the length scale. Once the dial was zeroed, the tray was released, and the weight of the tray was allowed to indent the tissue in the posterior neck at the specified location. After waiting several seconds to allow for viscoelastic effects to subside, calipers were used to measure the displacement of the weight tray by comparing the position of the released weight tray to the zero position, indicated by the locked dial. Once a measurement was taken, the process was repeated, each time adding additional 250 grams (g) calibration weights, up to a final weight of 1 kilogram (kg), plus the weight of the indenter and weight tray. This process was repeated for each of three testing positions.

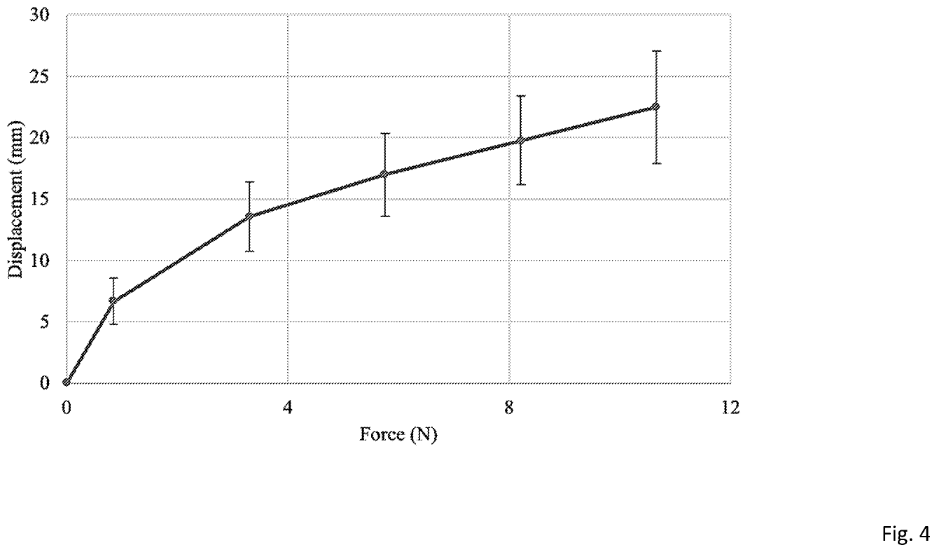

Data was collected by indenting in vivo tissues by physically contacting the posterior neck. The results were used to generate an empirical median displacement curve (see FIG. 4), which represents the mechanical response of the composite of skin, adipose tissue, muscle structures, and connective tissue between the indenter and (rigid) bone. The Ogden hyperelastic material, optimized by comparing FEM results to this empirical data, is assumed to be an isotropic homogeneous material. Therefore, the simulated Ogden material represents an isotropic homogeneous equivalent to the composite structure measured empirically. In other words, the optimized created Ogden material created may be interpreted as behaving how the tissues of the posterior neck would behave, if they were a single homogeneous isotropic material. This assumption is a result of using in vivo human tissues in empirical testing.

In total, 13 of 14 volunteers indicated that the highest tested weight (1 kg, plus the weight of the indenter and tray) was the maximum acceptable load. These volunteers generated 18 displacement-force datapoints each. One volunteer had a pain threshold of 500 g, plus indenter and tray weight. This participant netted 12 data points such that 246 displacement-force data points were collected in total.

Despite the range in demographics between the 14 volunteers, no recorded demographics appeared to have any correlation with displacement-force data. Variation in the data may be explained by various other factors that are difficult to quantify, such as muscle tension in the resting state, typical patient posture, skin thickness, and quantity of adipose tissue in the posterior neck. There was also no significant difference in displacement-force data between male and female participants. For these reasons, the data was processed into an empirical displacement-force curve by selecting the median displacement recorded for each static load. FIG. 4 depicts a median empirical displacement-force curve for the indentation device testing in accordance with an illustrative embodiment.

Using the test data, a two-dimensional axisymmetric FEM was constructed to simulate indentation of an Ogden hyperelastic material. The FEM included a 120 mm outer diameter (OD)×60 mm thick workpiece formed of the Ogden material, and a 4 mm cylindrical indenter. The workpiece was constructed with CAX4 rectangular solid deformable elements, and the indenter was constructed with RAX2 rigid wire elements. Mesh elements proximal to contact and large deformations had an average side length of 0.5 mm, and elements distal to contact were made larger (up to 2 mm side length) to reduce computation time. FIG. 5 shows an assembly of meshed components, revolved around the central axis of a two-dimensional axisymmetric FEM in accordance with an illustrative embodiment.

Referring to FIG. 5, the bottom edge of the workpiece was fixed in all degrees of freedom, and all other edges and nodes of the workpiece were left unconstrained. The indenter was fixed in rotation and lateral motion, and allowed only to move in the vertical direction as shown. The contacting surfaces were defined with no-penetration sliding contact, with a penalty factor of 0.5. The model was loaded via a concentrated force on the rigid body indenter, which increased in magnitude from 0 Newtons (N) to 10 N in increments of IN. After each IN increment was reached, the displacement of the contact surface of the indenter and workpiece was recorded.

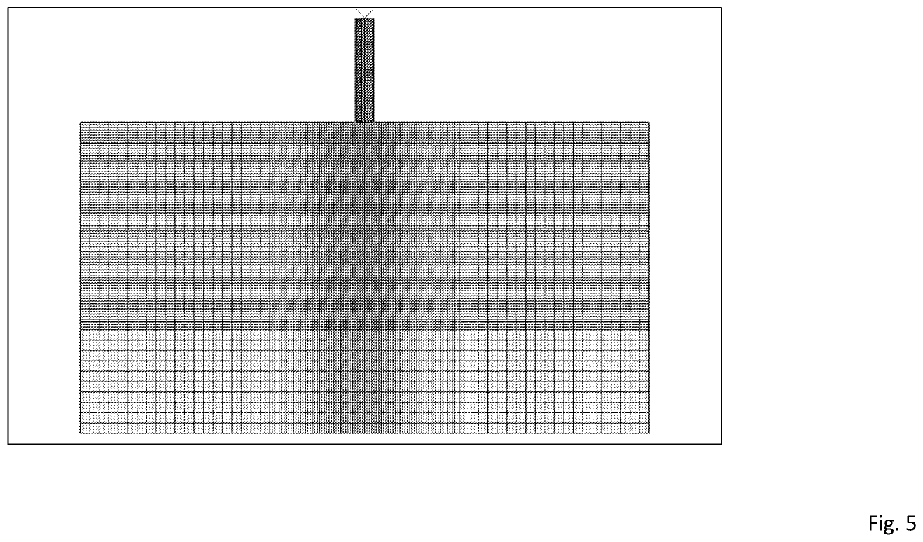

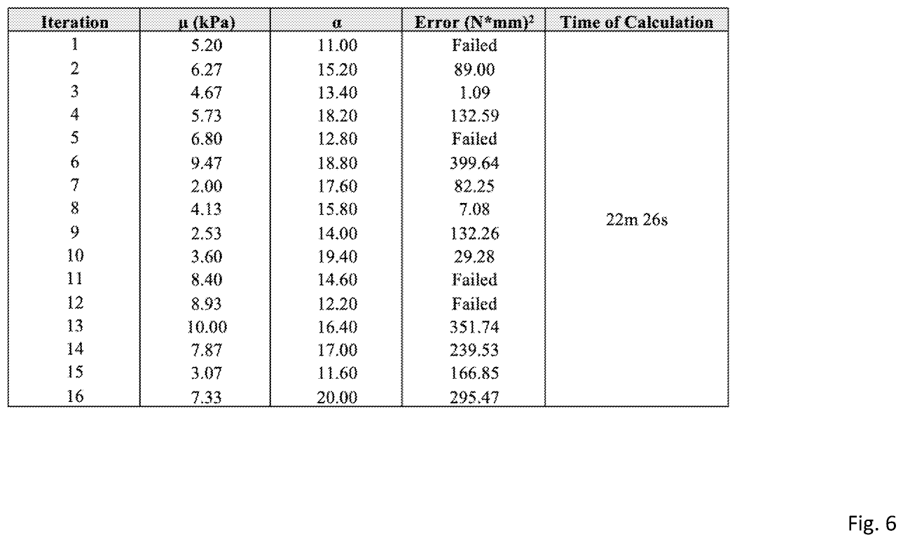

The parameters of the Ogden model were initialized using the following values: α=11 and μ=2 kPa. The FEM data file was accessed by the Abaqus module of the Simulia Isight software package for optimization, which was able to change the values of α and μ in successive iterations of the optimization routine (within the boundary conditions described in the table of FIG. 1). The design of experiments (DOE) stage of the optimization routine selected 16 combinations of α and μ parameters using an Optimal Latin Hypercube Sampling (OLHS) technique. The simulation was run for each of the 16 material configurations, and the displacement-force data was extracted from each result, and compared against the empirical data using the Data Matching module in Isight. The Data Matching module computed the sum of squared errors between the simulated data of each material configuration and the empirical median data. FIG. 6 is a table that depicts results of the DOE stage of optimization in accordance with an illustrative embodiment.

The simulation data obtained from the DOE stage of optimization was used as the initial dataset for constructing a GP model to be used in the Bayesian Optimization (BO) stage. For iterations 1, 5, 11, and 12, the simulation failed to reach the final load of 10 N, and the simulation was terminated prior to completion. For this reason, error values were not computed for these iterations, and the iterations were omitted from the initial GP input matrix D⁰. The initial GP input matrix D⁰ was used to construct a continuous function for the predicted error, given the input material parameters α and μ. The GP model code generated the continuous error function, as well as a 95% prediction interval (PI) for the continuous error function.

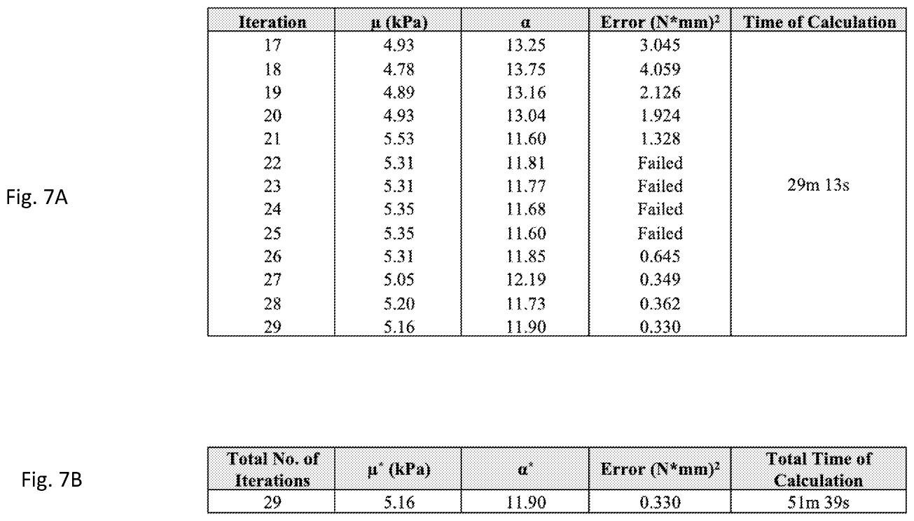

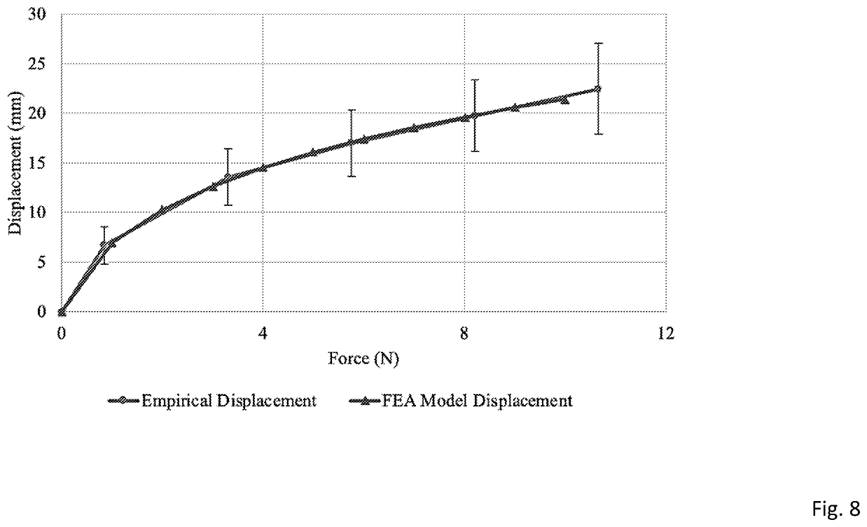

The BO code computed the expected value of the GP model function, and selected the combination of parameters α and μ which had the greatest expected improvement to the objective function (i.e., the parameters where the lowest error was expected). Those parameters were then passed to the Abaqus and Data Matching modules to compute the true error. This process was iterated 12 times before reaching an optimal solution, giving a total of 29 iterations across the entirety of the two-stage optimization process. In the event that the iteration point selected by the BO routine resulted in a premature termination in Abaqus, this pair of parameters was discarded, and the next best parameters were selected from the GP model of the previous iteration. FIG. 7A is a table that depicts Bayesian Optimization with Gaussian Process modeling results in accordance with an illustrative embodiment. FIG. 7B shows a table that summarizes the optimized material parameters of the Ogden material, the minimized error of the model, the number of iterations, and the total time of calculation in accordance with an illustrative embodiment. The constitutive strain energy equation of the optimized Ogden material is expressed in Equation 4 below. FIG. 8 shows a plot of the optimized material displacement-force curve overlayed with the empirical data in accordance with an illustrative embodiment.

$$W = \frac{2 ( 5.16 kPa )}{11 . {9}^{2}} ( {λ}_{1}^{11.9} + {λ}_{2}^{119} + {λ}_{3}^{11.9} - 3 ) . \qquad Equation 4$$

The optimized Ogden material was implemented in a second FEM, constructed to simulate a cross-section of the posterior neck in two dimensions. The geometry of the neck cross section was obtained from a measured size of the deep neck muscle group across a large range of volunteers using ultrasonography techniques. Magnetic resonance imaging (MRI) images were also obtained to analyze the size and tone of neck muscles. An MRI cross-section at the C3 vertebrae was imported to a sketch in a Solidworks model, where the cross-sections of the deep muscle group, outer tissue group, and vertebrae were traced. Sharp corners and complicated geometry were smoothed and simplified for FEM meshing purposes. The traced tissue and bone groups were scaled to their average sizes.

The traces were exported from Solidworks into Abaqus, which was used to generate an FEM mimicking the geometry of the neck from the scans. A 4 mm OD indenter was introduced to the assembly as well. The indenter and bone were treated as rigid bodies, and were modeled with R2D2 rigid body wire elements for plane strain. The deep muscle group and the outer tissue group were both modeled using CPS4R rectangular solid deformable elements. Both solid deformable components were given the optimized Ogden material properties, and the parts were bonded together at their mutual contact surface. Structuring the model in this way ensures that the deep muscles and outer tissue continue to behave as if they were a single homogenous isotropic body per the assumptions of this model (modeling them as two separate components makes isolating the effects in the deep muscle group far easier).

All components were formed to have an average mesh element side length of 1 mm. The vertebrae component is fixed in all degrees of freedom. The indenter component is only allowed to translate along its central axis. The vertical edge on the left side of the outer tissue component is allowed to translate vertically, but not allowed to translate horizontally or rotate. The horizontal edge on the bottom right side of the outer tissue component is allowed to translate horizontally, but not vertically, and is also not allowed to rotate. The elements are otherwise unconstrained. As previously mentioned, the deep muscle component and the outer tissue component are bonded, but are in no-penetration contact with both the bone and indenter rigid bodies. Transverse motion has an associated penalty factor of 0.5. The indenter was loaded to 10 N, after which the maximum principal strain at each node in the deep muscle group was recorded.

Indentation testing on the plane strain cross-section model was performed at a range of indenter locations and orientations to determine the optimal placement. First, the optimal position was determined by testing indentation normal to the surface of the skin at a coarse range of positions. An optimal region was defined from the results of the coarse range-finding data, and a smaller range was tested in finer positional increments to determine the optimal position of the indenter. A similar technique was used to find the optimal indenter angle at the selected optimal position. First, indentation was simulated across a coarse range of angles centered about the outer tissue normal vector. An optimal range of angles was determined from the coarse range-finding data, and a smaller range was tested in finer angular increments to determine the optimal angle of the indenter. The end result was an indenter position and orientation optimal for maximizing the nodal average of the maximum principal strain across the deep muscle group. For each indentation simulation, the maximum principal strain was measured at each node in the deep muscle group component.

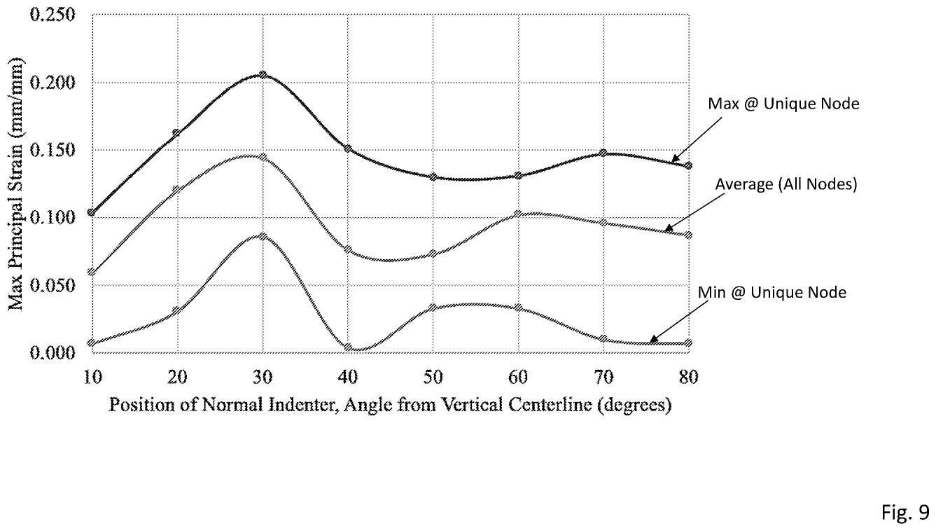

Indentation was simulated across a coarse range of positions. The positions were determined by drawing construction lines from the center of the spinal axis to the surface of the outer tissue component. Construction lines were drawn every 10°, beginning from the vertical axis and spanning a range from 10-80°. FIG. 9 shows a plot of the maximum, minimum, and average nodal values of max principal strain in the deep muscle group as a function of indenter position in accordance with an illustrative embodiment.

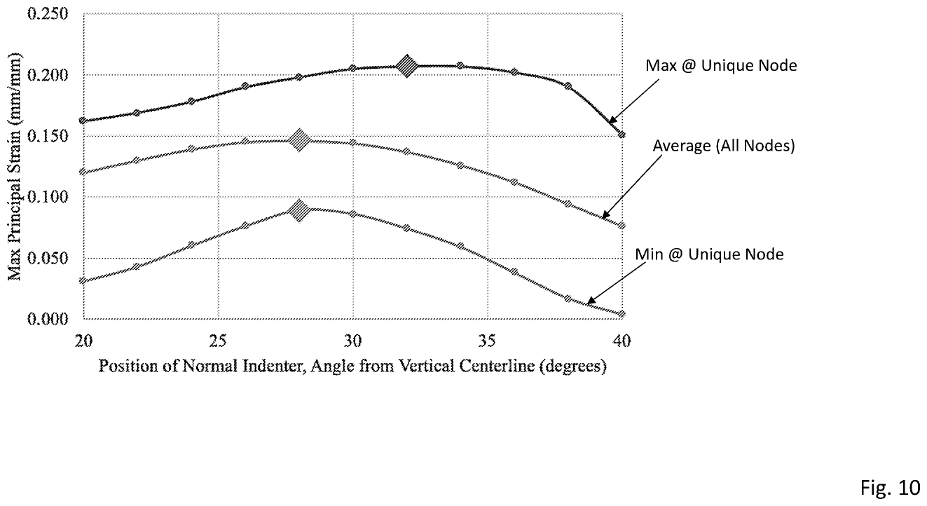

Based on the results of the coarse position range-finding, a maximum average strain value appeared to be present somewhere in the range of positions 20-40° from the vertical centerline. For the next set of simulations, the indenter position was varied across this range in increments of 2°. FIG. 10 shows a plot of the maximum, minimum, and average nodal values of max principal strain in the deep muscle group as a function of indenter position for the finer range in accordance with an illustrative embodiment.

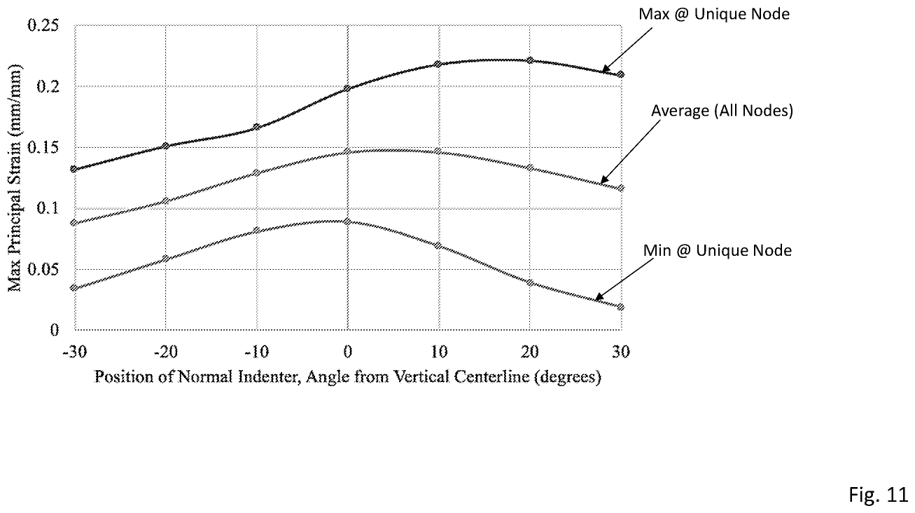

The peak values shown in FIG. 10 are highlighted with enlarged diamond-shaped markers. From this data, an optimal indenter position of 28° was selected. At this optimal position, indentation testing was next performed at a coarse range of angles ranging from negative 30° to 30° with respect to the normal vector of the outer tissue component surface. Tests were spaced by 10° increments for this setup. FIG. 11 shows a plot of the maximum, minimum, and average nodal values of max principal strain in the deep muscle group as a function of indenter angle across the coarse range in accordance with an illustrative embodiment. It is noted that negative angle values refer to angles measured clockwise from the normal vector, and positive angle values refer to angles measured counter-clockwise from the normal vector.

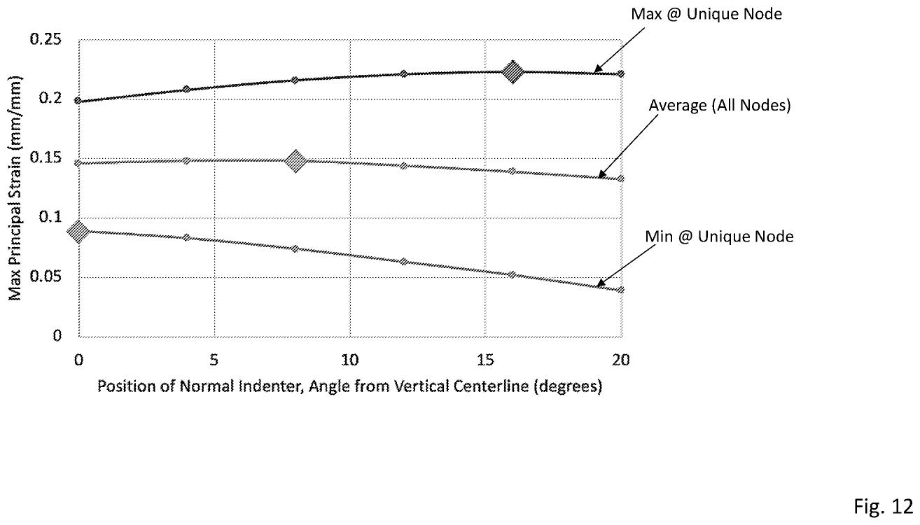

Based on the results of the coarse angle range-finding, a maximum average strain value appeared to be present somewhere in the range of angles 0-20° (counter-clockwise) from the normal vector at the optimal position. For the next set of simulations, the indenter angle was varied across this range in increments of 4°. FIG. 12 shows a plot of the maximum, minimum, and average nodal values of max principal strain in the deep muscle group as a function of indenter angle for the finer range in accordance with an illustrative embodiment. The peak values shown in FIG. 12 are highlighted with enlarged diamond-shaped markers. From this data, and optimal indenter angle of 8° (counter-clockwise) was selected. Thus, the final optimized position and orientation of the indenter was selected at a position 28° lateral from the vertical axis measured from the spinal center axis, at an angle of 8° counter-clockwise from the outer tissue normal vector at this position.

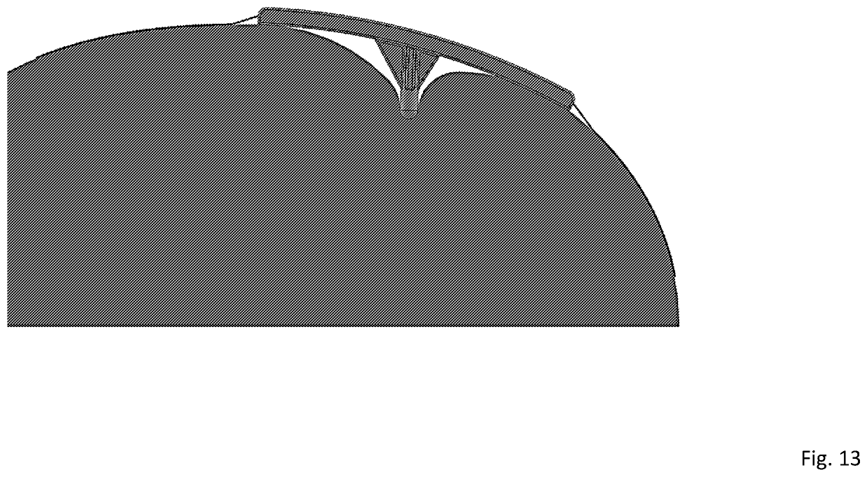

The optimized indenter position and orientation obtained from the successive range-finding and fine-tuning simulation schemes was used to create a preliminary device design for the treatment of trigger points in the deep posterior neck muscles. The deformed geometry of the neck section was exported from Abaqus to Solidworks, and used as a guide for constructing the geometry of the device. FIG. 13 shows a side view of the indenter device attached to the neck in accordance with an illustrative embodiment.

The device design included a 4 mm OD indenter tip affixed to a larger curved base flange. The indenter tip is supported by a series of ribs, adding rigidity to the system. The base flange is curved so as to contact the undeformed regions of skin on the posterior neck. The device is designed such that when the medial edge of the curved base flange (the left side of the device as shown in FIG. 13) is aligned with the centerline of the spine, the indenter tip will apply pressure at the optimal position and orientation. At this indentation location, the device, used properly, would be pressed into the neck tissue such that the edges of the base flange rested on top of the undeformed regions of the neck tissue, away from the indentation location. The device is affixed to the user's neck via either medical or kinesiology tape, or by an adjustable strap.

Although the simulations ranged in indentation force up to 10 N, this indentation force was considered to be near or even exceeding the pain tolerance of the participants in the empirical data collection study. As such, the indenter dimensions were chosen such that the indentation force applied would be closer to 5 N, which is a much more comfortable load for short term (1-2 hour) use of the device. As discussed below, the device may be altered with improvements which may improve the therapeutic effects via alternative mechanisms—for instance, heat, vibration, electro-stimulation, and/or other forms of excitation may be added to more complicated versions of the device.

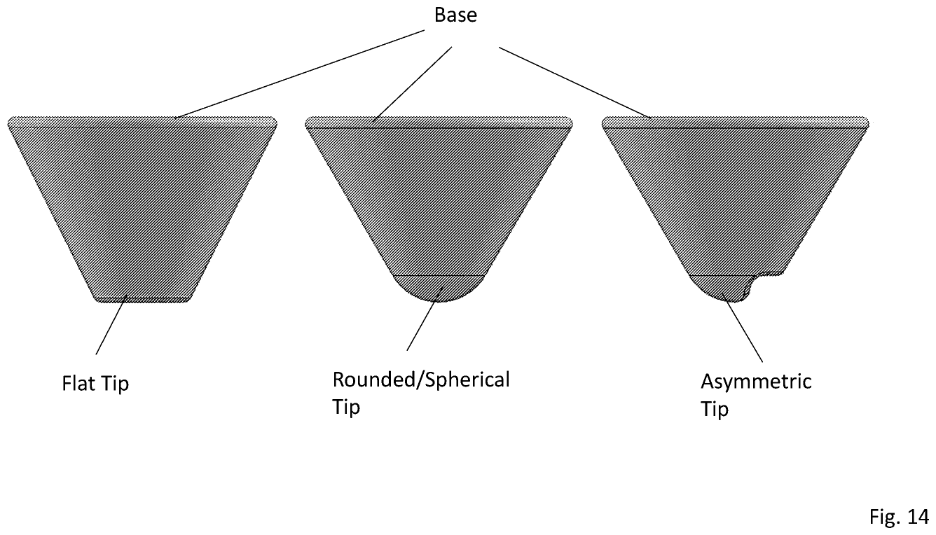

Described below are various embodiments of an indenter device. FIG. 14 depicts conical indenter tip designs in accordance with an illustrative embodiment. Each of the tip designs includes a base, which has a large area and low pressure and is used to support tape or a strap which secures the indenter to a patient. The indenter devices also include a small area, high pressure tip in the form of a flat tip, a ball/spherical tip, or an asymmetric tip. The tip geometry influences contact pressure in the skin/muscle tissue of the user. The use of a conical shape concentrates pressure at the application point, and is able to achieve high pressure in the tip with comparatively low pressure at the base.

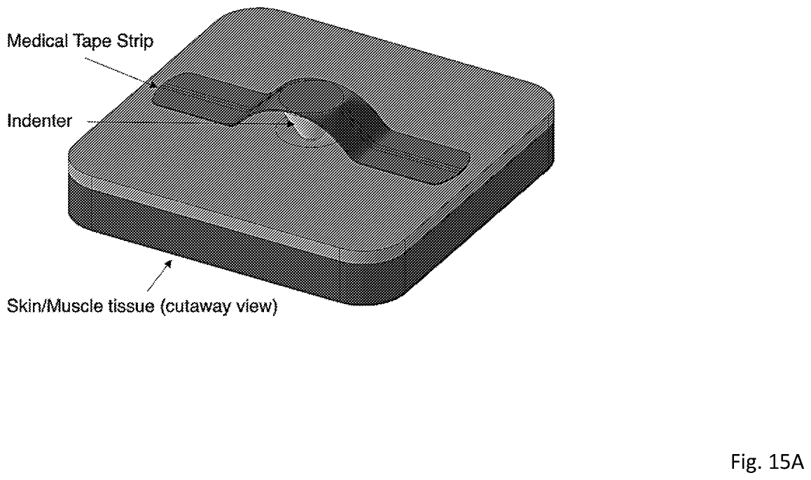

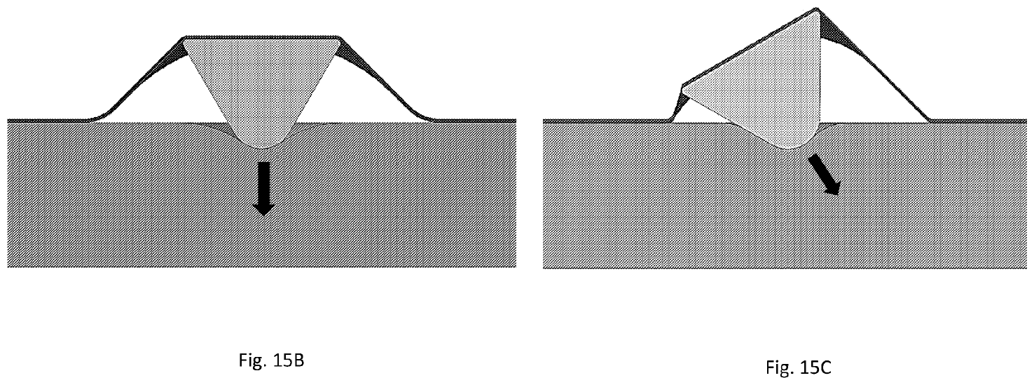

FIG. 15A depicts a single indenter secured to skin/muscle tissue with a mount in the form of a strip of tape in accordance with an illustrative embodiment. Any type of tape can be used, such as kinesiology tape, zinc-oxide tape, elastic adhesive bandages, etc. The indenter can be vertical (i.e., 90 degrees) or angled relative to the skin surface, depending on the patient and location of the stressed tissue. FIG. 15B is a cross-sectional view that depicts use of a single indenter in a vertical orientation in accordance with an illustrative embodiment. FIG. 15C is a cross-sectional view that depicts use of a single indenter at an angled orientation in accordance with an illustrative embodiment. As discussed, the angled orientation increases therapeutic effect.

The above-described conical indenter produces a point contact at the tip of the cone, as illustrative in FIG. 15. FIG. 16 depicts a comparison of a cone (or point) indenter to a line indenter in accordance with an illustrative embodiment. The line indenter is in the form of a triangular prism (or extended wedge) such that the indenter produces line contact when mounted to a patient. The line contact can be used to hit multiple trigger points simultaneously with a single indenter. Similar to the point indenter, the line indenter (triangular prism) can be oriented in a vertical orientation (i.e., 90 degrees relative to the skin) or at asymmetric/angled positions.

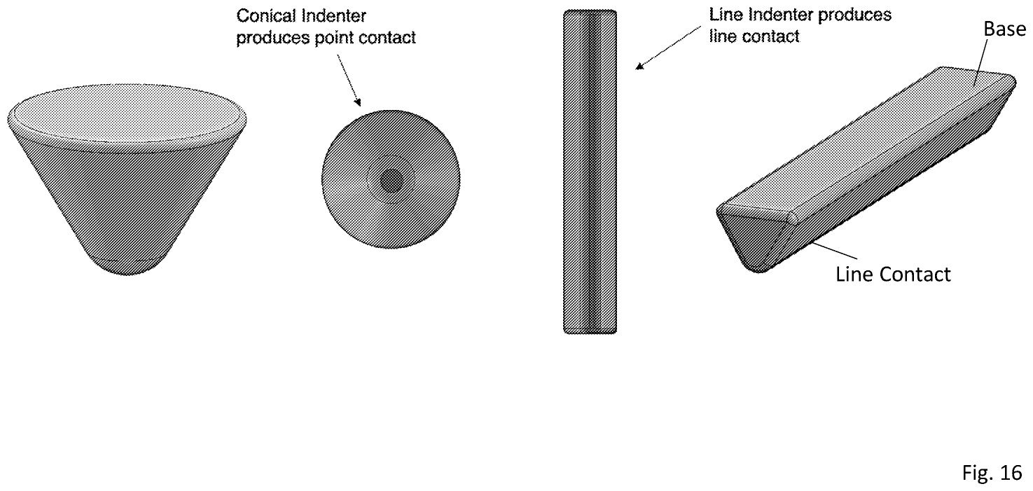

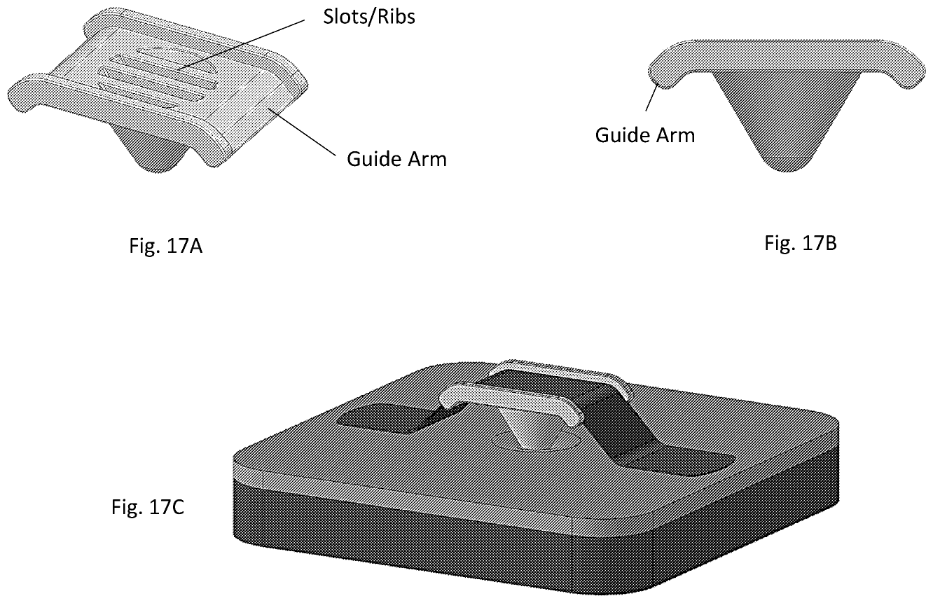

FIG. 17A is a perspective view of a single indenter with a mount guide in accordance with an illustrative embodiment. FIG. 17B is a side view of the single indenter with the mount guide in accordance with an illustrative embodiment. FIG. 17C depict the single indenter with the mount guide mounted to a patient in accordance with an illustrative embodiment. As shown, the mount guide forms the base of the indenter and includes guide arms that guide the angle of the tape (or strap or other mount) as it leaves the indenter. Specifically, the tape (or other mount) sits flat on the guide arms and does not wrap around the circular profile of the conical base. The mount guide can also include slots/ribs to maintain thickness and structural stability for injection molding. The use of the mount guide allows for easier and more consistent adhesion of the indenter to the tape (or more stable placement of a strap or other mount).

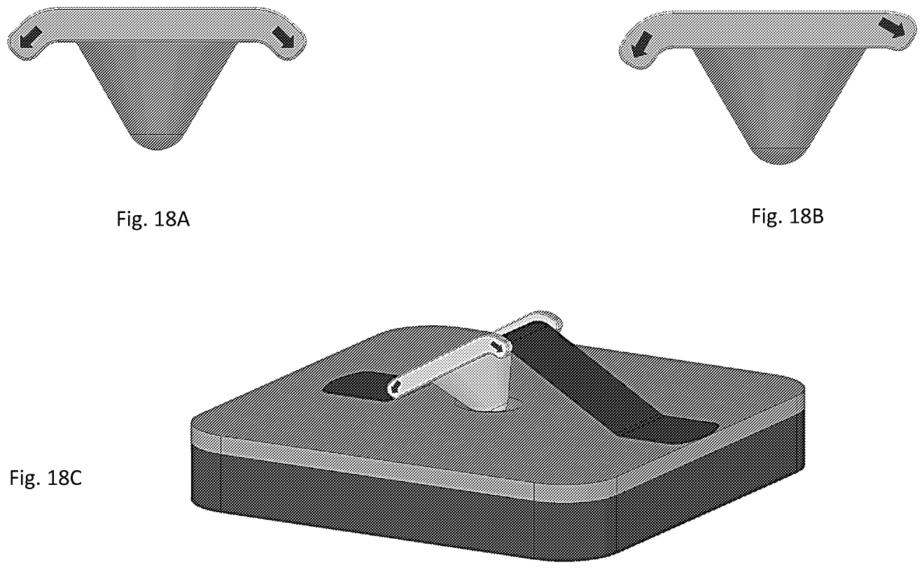

Similar to the other indenters discussed above, the single indenter with a mount guide can also be mounted vertically relative to the patient or at an angled/asymmetric position to increase the therapeutic effect. In one embodiment, the mount guide can include arrows to guide the user with respect to the proper angle that the tape (or strap) is to leave the mount guide such that a desired orientation of the indenter is achieved. FIG. 18A depicts an indenter with a mount guide that is annotated with arrows to guide tape/strap application and result in a vertical orientation in accordance with an illustrative embodiment. FIG. 18B depicts an indenter with a mount guide that is annotated with arrows to guide tape/strap application and result in an angled (or asymmetric) orientation in accordance with an illustrative embodiment. Specifically, the annotations are at different angles to cause the asymmetric mounting. FIG. 18C depicts the indenter of FIG. 18B mounted to a patient at the asymmetric (angled) orientation depicted by the guide arrows on the mount guide in accordance with an illustrative embodiment. The guide arrows can be added to the mount guide of the indenter as decals (e.g., stickers) or alternatively the guide arrows can be built in to the mold geometry for the indenter.

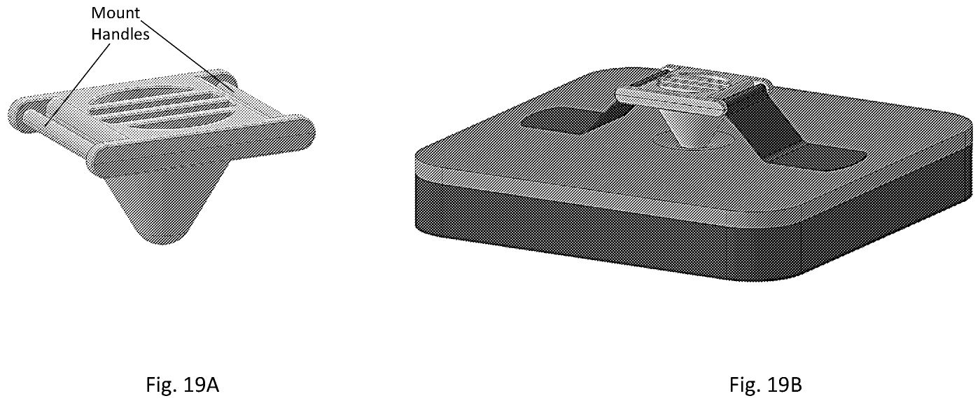

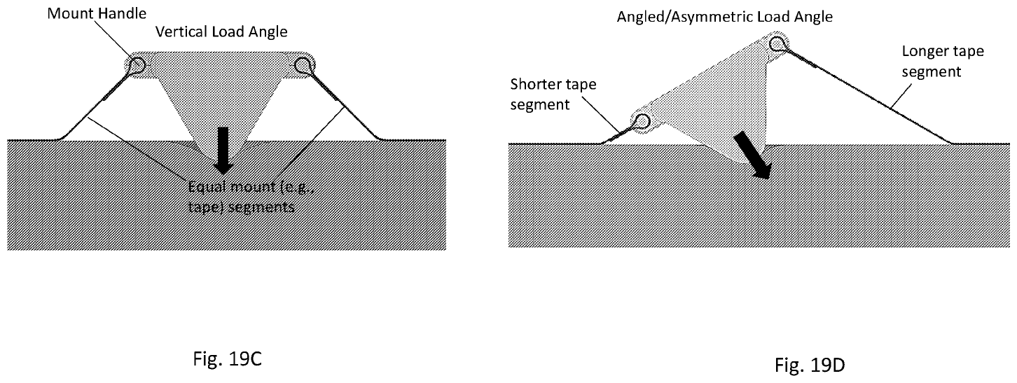

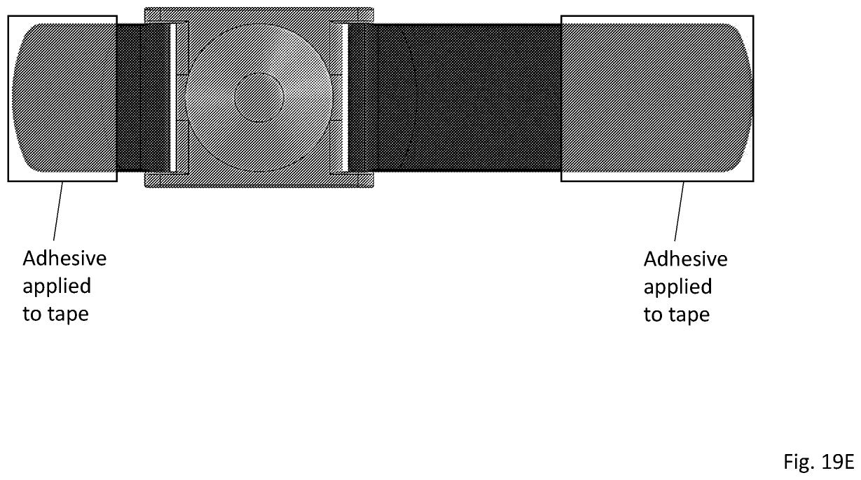

In another illustrative embodiment, the base of the indenter can be formed to include one or more mount handles that receive individual pieces of tape (or strap or other mount) to secure the indenter to a patient. This allows the tape, etc. to be separated into multiple smaller pieces. The separate pieces are attached to either side of the indenter at the mount handle. The mount handles can be in the form of cylinders, tubes, spindles, etc. formed adjacent to the main portion of the base, with a gap (to receive the tape or strap) formed between the mount handle and the main portion of the base. In one embodiment, sidewalls of the base extend past the main portion of the base and support the mount handles at a distance from the main portion of the base to form the gap. FIG. 19A is a perspective view of a single indenter with a base that includes mount handles in accordance with an illustrative embodiment. FIG. 19B depicts the single indenter with the base that includes mount handles mounted to a patient in accordance with an illustrative embodiment.

Using the embodiment of FIG. 19, the vertical or angled orientation can be controlled by the length of tape used on each side of the indenter base. FIG. 19C depicts how equal size tape segments attached to the mount handles results in a vertical load angle of the indenter in accordance with an illustrative embodiment. FIG. 19D depicts how different size tape segments attached to the mount handles can be used to achieve an angled/asymmetric load angle in accordance with an illustrative embodiment. Guide features such as the mount guide and mount handles with annotations can assist the user with application of tape/strap at the correct angles. However, such features do not limit use of the device to specific angles because tape or a strap is a non-rigid two-force member. As a result, users can ignore any indications and apply the tape/strap at any desired angle to achieve a desired orientation of the indenter. Additionally, in one embodiment, adhesive can be applied to only certain portions of the tape to help control the angle of the indenter. Applying tape too close to the indentation site can cause slack, resulting in no pressure applied. FIG. 19E depicts an indenter with mounting tape in which adhesive has only been applied to certain selected areas of the tape (highlighted) to help control indenter orientation and effectiveness in accordance with an illustrative embodiment.

In another embodiment, the indenter can include a pivot arm on one side of the base. The pivot arm is designed to contact the skin of the patient and act as a guide to control a desired orientation of the indenter. For example, instead of having a mount handle (or guide) on each side of the base, the base can include one mount handle (or guide) on one side of the base and a pivot arm on the other side of the base. The use of a pivot arm improves stability of the indenter, making it more difficult for the device to fall over out of plane and lose tension. The use of a pivot arm also provides better control over indenter angle and depth. FIG. 20A depicts an indenter with a base having a pivot arm on one side and a mount handle on the other side in accordance with an illustrative embodiment. FIG. 20B depicts the indenter with the pivot arm mounted such that the pivot arm is in contact with the skin and acts as a mounting guide to control indenter orientation in accordance with an illustrative embodiment. It is noted that instead of a mount handle opposite the pivot arm, any other configuration may be used such as a mount guide, etc.

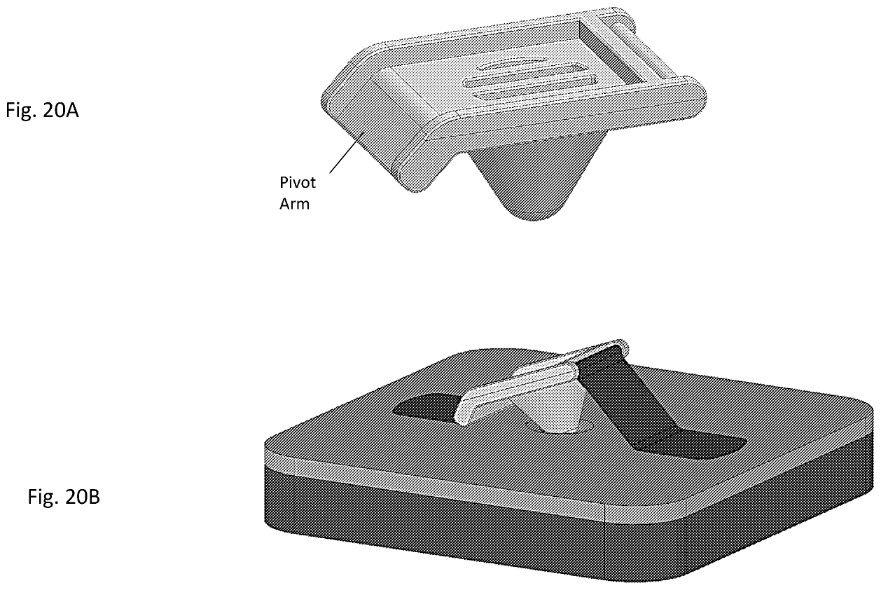

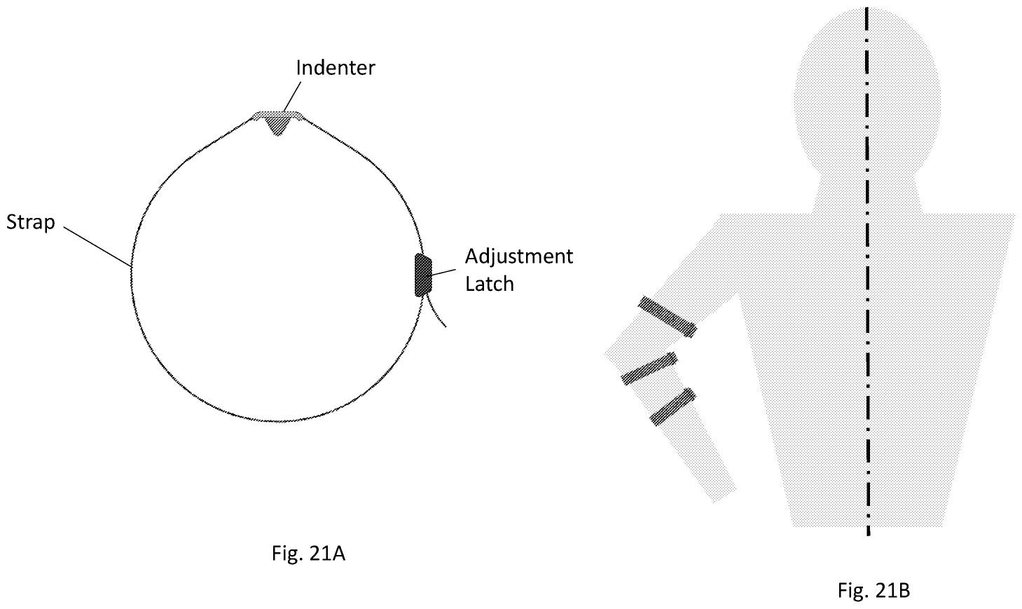

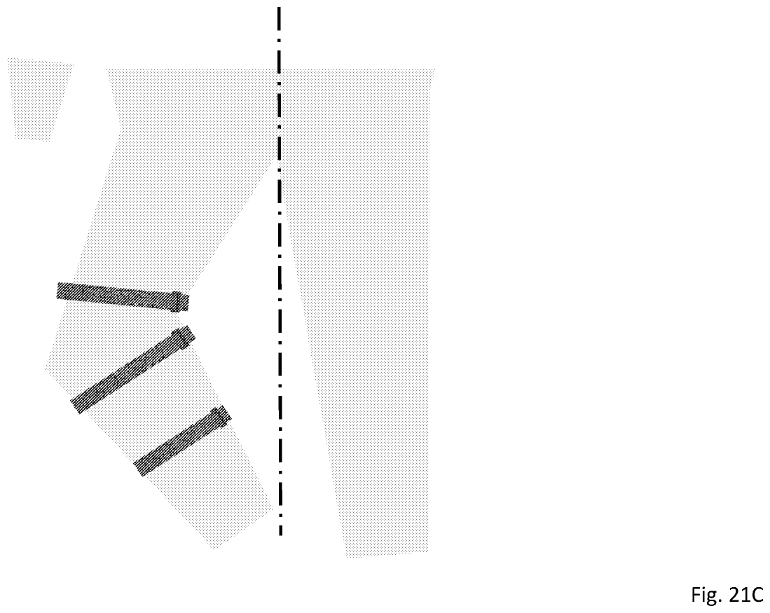

In one embodiment, instead of using tape as the mount, a strap can be used to secure one or a plurality of indenters to a patient. The strap can fit over (or through) the indenter (e.g., through the mount handles discussed above) and can be secured around an appendage of the user such as an arm, hand, leg, foot, etc. The strap can include an adjustment latch that allows that strap to be tightened to a desired degree, which controls the amount of pressure applied by the indenter(s). FIG. 21A depicts an indenter mounted to a strap in accordance with an illustrative embodiment. The use of a strap eliminates the need for having an adhesive in contact with the skin of the user. Also, the strap allows for easy adjustment to control the position and angle of the indenter, and the load applied by the indenter. FIG. 21B depicts the indenter strap mounted to various locations on an arm of a patient in accordance with an illustrative embodiment. FIG. 21C depicts the indenter strap mounted to various locations on a leg of a patient in accordance with an illustrative embodiment.

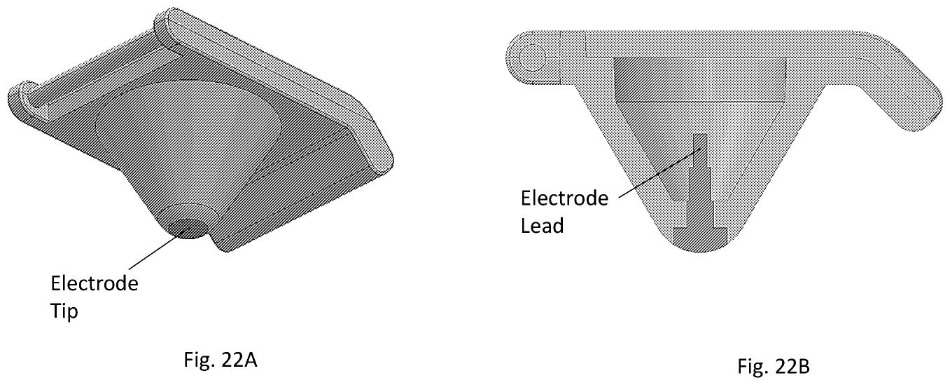

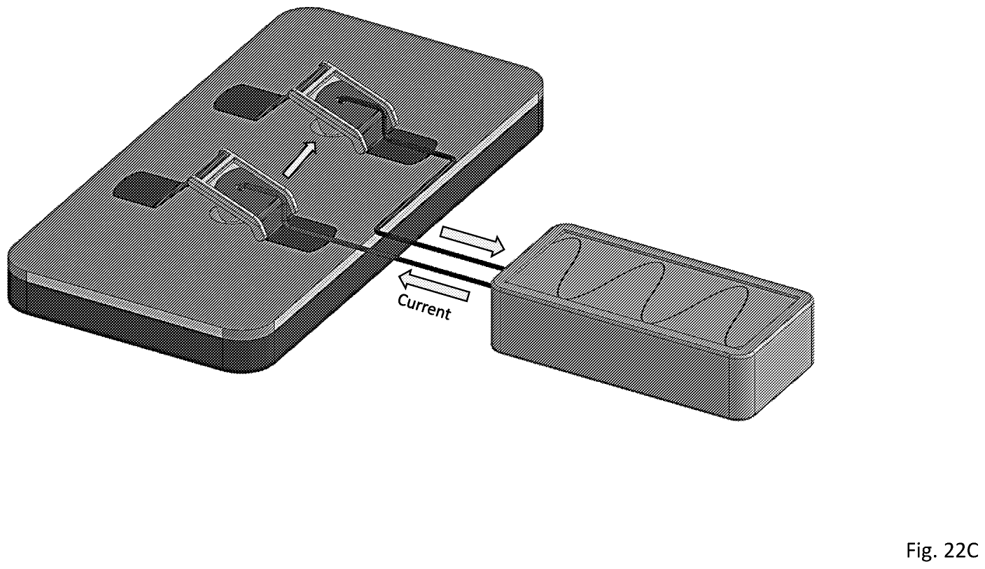

In another embodiment, the indenters can include electrical stimulation, which is a therapy commonly used to treat muscle injuries. For example, the indenter tip can include a conductive electrode that is flush with the indenter body. The electrode can be inserted and used to replace the plain tip of the indenter. The electrode can be used to apply a low amplitude electrical waveform across a target muscle. The electrode insert can attach to wires or leads that connect to an electro-stim machine or other energy source to provide the electrical waveform. FIG. 22A is a bottom view of an indenter with a conductive electrode tip in accordance with an illustrative embodiment. FIG. 22B is a cross-sectional view that shows the lead of the electrode inside of the indenter cone in accordance with an illustrative embodiment.

FIG. 22C depicts a pair of indenters with electrodes mounted to a patient and connected to an electrical stimulation machine in accordance with an illustrative embodiment. In one embodiment, the 2 electrodes can be activated in an alternating pattern to stimulate a relatively large area of muscle tissue. FIG. 22C depicts 2 indenters, but fewer or additional indenters can be used for electrical stimulation in alternative embodiments. Additionally, while 2 or more indenters can be used to complete the circuit with the stimulation machine, only a subset of the indenters may include an electrical stimulation electrode. It is also noted that while the images of FIG. 22 depict the pivot arm embodiment of the indenter, it is to be understood that the electrical stimulation electrode can be incorporated into any of the indenters described herein.

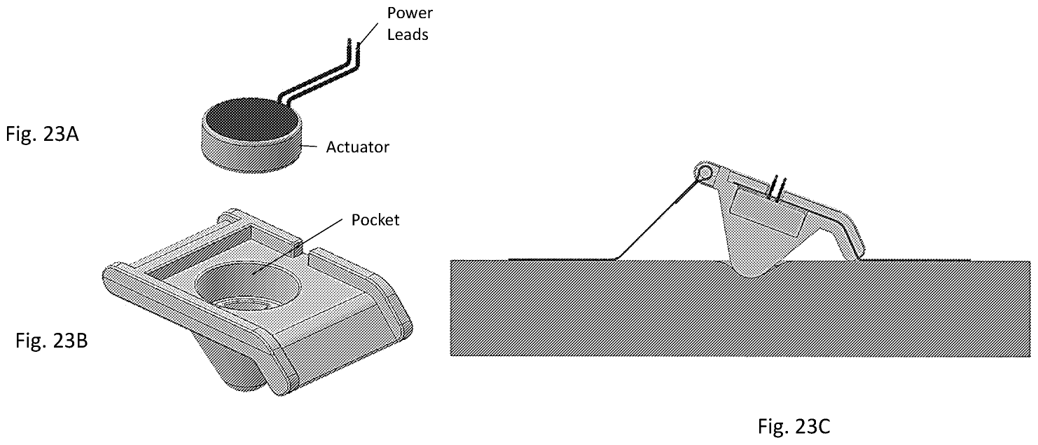

In one embodiment, the indenters can also include a vibration element such as a linear actuator to perform vibrations of the tissue. The linear vibratory actuator can be powered by an external source such as a battery, kinematic energy source, etc. The actuator can mount into a pocket formed in the base and/or body of the indenter, and can include leads extending from the base to receive power. FIG. 23A depicts a linear vibratory actuator with power leads in accordance with an illustrative embodiment. FIG. 23B depicts an indenter with a pocket to receive the linear/vibratory actuator in accordance with an illustrative embodiment. FIG. 23C depicts the indenter with linear/vibratory actuator mounted to a patient to induce vibration in accordance with an illustrative embodiment. The vibration can be pulsed or modulated for enhanced therapeutic effect. Additionally, the vibration can be low frequency, high frequency, or ultrasonic.

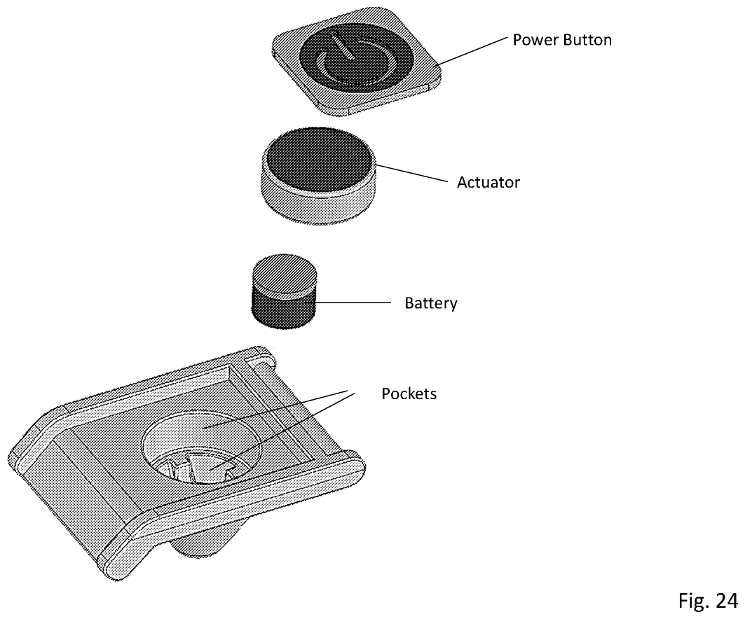

In another embodiment, an indenter can include a vibrating linear actuator that is powered onboard by a battery. In such an embodiment, the indenter includes one or more pockets that are sized to receive a battery, the linear vibratory actuator, and a power switch/button that allows the actuator to be toggled on and off to control vibration. FIG. 24 is an exploded view that depicts an indenter with a vibration actuator and an onboard battery in accordance with an illustrative embodiment. While the images of FIGS. 23 and 24 depict the pivot arm embodiment of the indenter, it is to be understood that the vibration actuator can be incorporated into any of the indenters described herein.

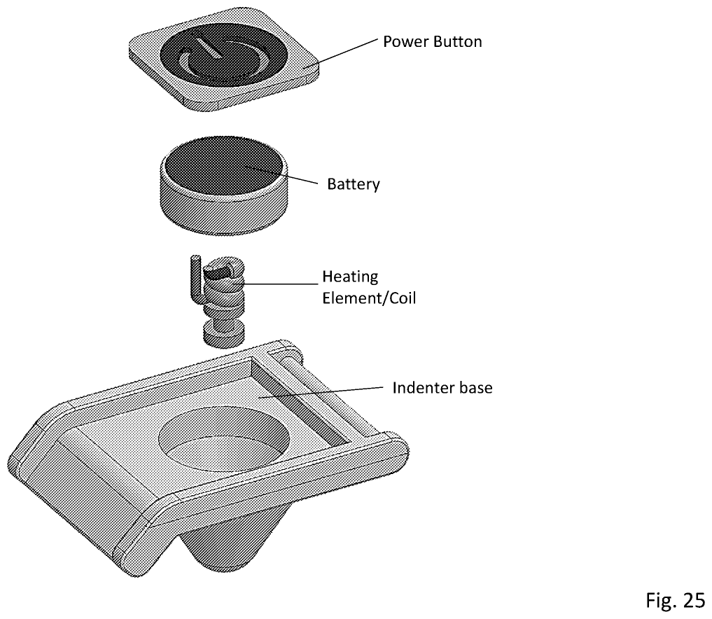

In another embodiment, the indenter can include a heating element to apply heat to the targeted muscles. For example, a heating element with a conductive tip can be incorporated into the indenter such that the indenter applies heat and pressure simultaneously. The heating element can be powered by an onboard battery or alternatively by a remote power source. FIG. 25 depicts an exploded view of an indenter with an incorporated heating element in accordance with an illustrative embodiment. The heating element can similarly be used with any of the indenters described herein, and is not limited to the depicted indenter with a pivot arm.

In one embodiment, the linear vibrator, the electrical stimulator electrode, and/or the heating element can be powered by motion-generated power that results from user movement. For example, motion of the arms or legs while walking generates energy that can be captured by a spinning weight mechanism that operates similar to the automatic winding mechanism of a watch. Energy can also be generated by back-EMF from forcing motion of an electromagnetic motor. FIG. 26A depicts an energy harvester in the form of an unbalanced weight that spins on an arm and that is mounted to a user in accordance with an illustrative embodiment. FIG. 26B depicts an energy harvester in the form of spinning weight that drives a spindle of an electromagnetic motor to generate back-EMF in accordance with an illustrative embodiment. The generated energy can be stored in a battery, or dissipated directly through activation of an actuator, heating element, electrode, etc.

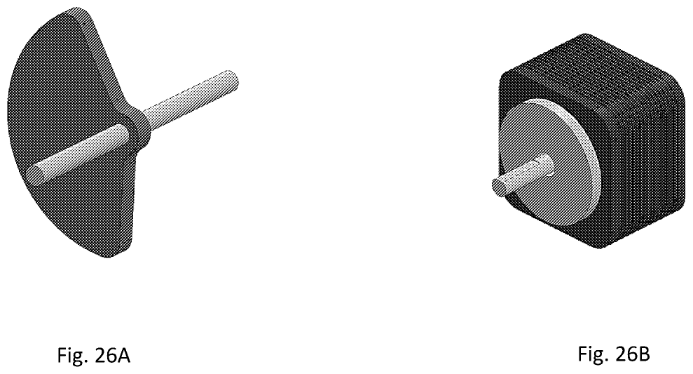

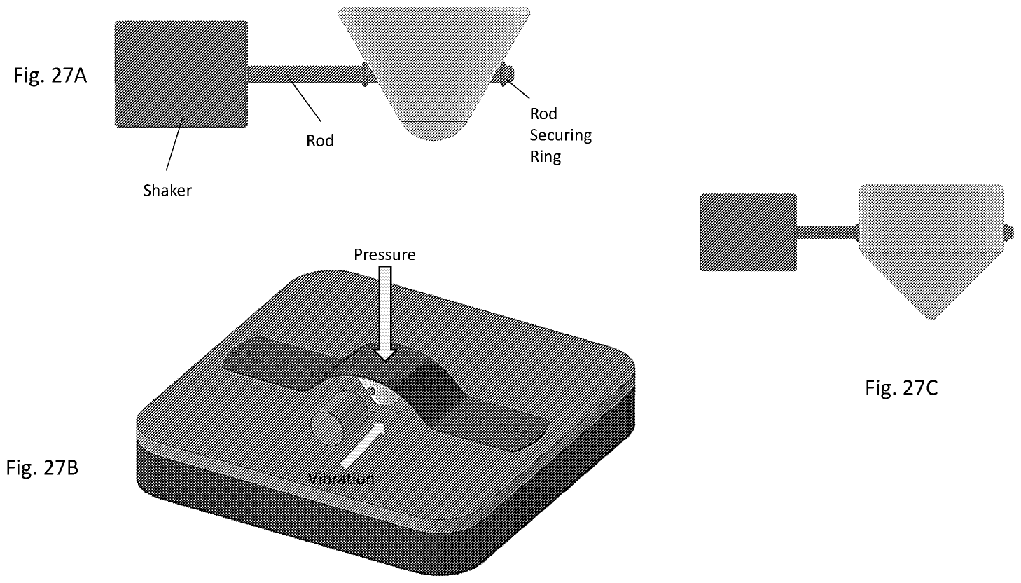

In another embodiment, the indenter can include a miniature shaker that mounts to a body of the indenter and that is used to provide horizontal massage while pressure is being applied by the indenter. In one implementation, a through hole is made in the lower portion of the body of the indenter. The miniature shaker is attached to the indenter via a rod that extends through the body of the indenter, where the rod can be secured by rubber rings that attach to the rod and prevent the rod from exiting the through hole in the indenter. The shaker can be powered by an internal battery or external power source, depending on the embodiment. The vibration can be low frequency, high frequency, or ultrasonic. FIG. 27A shows an indenter with an attached miniature shaker in accordance with an illustrative embodiment. FIG. 27B shows the indenter with attached miniature shaker mounted to a user in accordance with an illustrative embodiment. FIG. 27C depicts a conical-cylindrical indenter with an attached miniature shaker in accordance with an illustrative embodiment. As shown, the indenter includes a cylindrical base through which the mounting rod for the miniature shaker extends. A cone portion of the indenter is mounted to the cylindrical base, and rings are again used to secure the shaker.

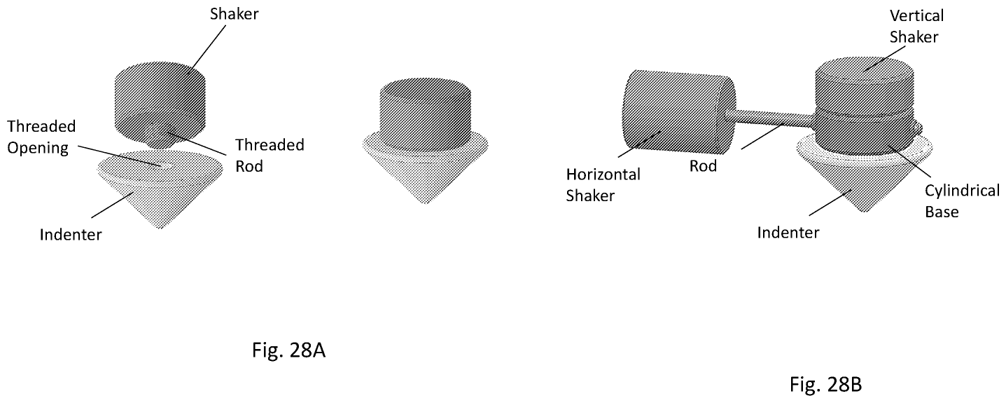

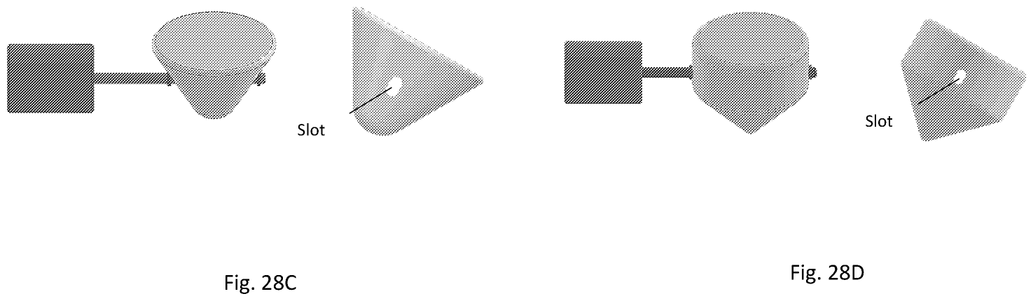

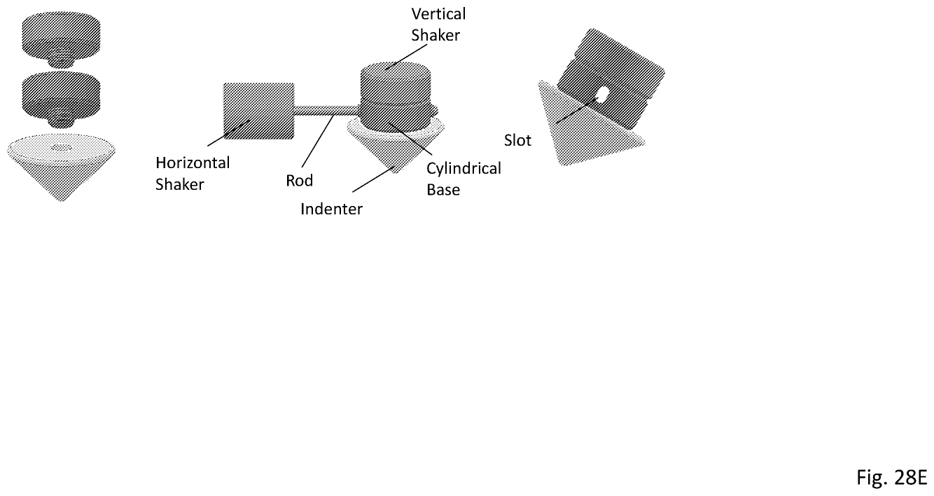

Various other embodiments of an indenter with vibration (either vertical and/or horizontal) are also envisioned. FIG. 28A depicts a conical indenter with a vertical miniature shaker (i.e., vibrator) mounted to a base of the indenter in accordance with an illustrative embodiment. In the embodiment shown, the shaker includes a threaded rod that mates with a threaded opening in the base of the indenter. As a result, the tape (or strap) can go over the shaker to apply vertical (or angled) pressure while the shaker provides vertical (or angled) vibration. Specifically, the shaker can provide vertical vibration when the indenter is mounted vertical (i.e., 90 degrees relative to the skin). The shaker can provide angled/asymmetric vibration when the indenter is mounted at an angle relative to the skin using tape or a strap, as discussed herein.

FIG. 28B depicts a conical-cylindrical indenter with a vertical shaker and a horizontal shaker in accordance with an illustrative embodiment. The vertical shaker is attached to the indenter via a threaded connection, and the horizontal shaker can be attached to the indenter via a rod, as shown. In addition to pressure from tape (or a strap) that goes over the vertical shaker, this version additionally provides vertical (or angled) vibration along with horizontal vibration.

FIG. 28C depicts a conical indenter with horizontal vibration at an angled orientation in accordance with an illustrative embodiment. A through hole in the indenter receives a rod to which a miniature shaker is mounted to provide the horizontal vibration. The through hole can be oval or a slot to accommodate the indenter being positioned at any angle relative to the shaker. FIG. 28D depicts a conical-cylindrical indenter with horizontal vibration at an angled orientation in accordance with an illustrative embodiment. A through hole in the cylindrical base of the indenter receives a rod to which a miniature shaker is mounted to provide the horizontal vibration. As shown, the through hole can be oval or a slot to accommodate the indenter being positioned at any angle relative to the shaker. FIG. 28E depicts a conical-cylindrical indenter with both vertical and horizontal shakers to provide vibration at an angled orientation in accordance with an illustrative embodiment. A through hole is formed in the cylindrical base that threads into the indenter. The through hole receives a rod to which a miniature shaker is mounted to provide the horizontal vibration. As shown, the through hole can be oval or a slot to accommodate the indenter being positioned at any angle relative to the shaker.

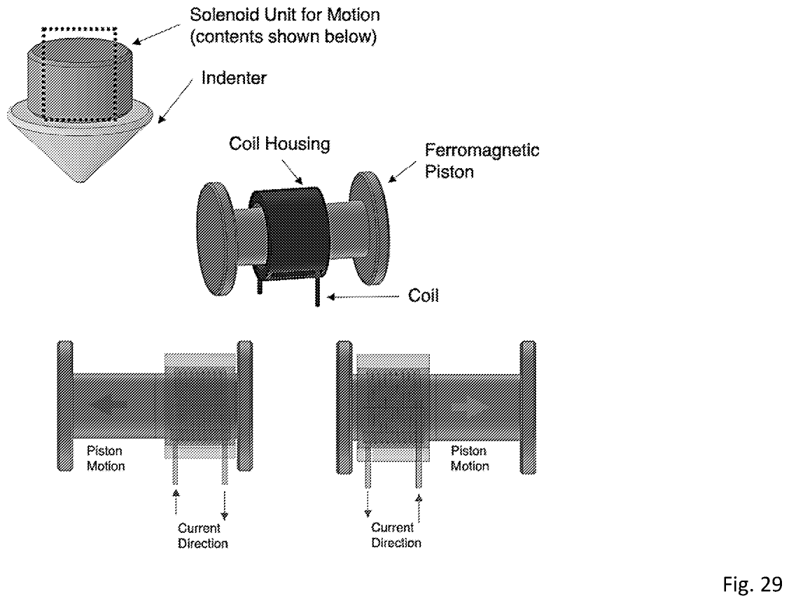

In one embodiment, the motion/vibration of the indenter can be driven using a solenoid, which can be actuated by switching direct current on and off using electronics such as a transistor, MOSFET switch, etc. In such an embodiment, digital logic or a controller can be used to control the solenoid. Alternatively, the solenoid can be actuated using an alternating current. FIG. 29 depicts a solenoid incorporated into a cylindrical base of an indenter, along with inner workings of the solenoid in accordance with an illustrative embodiment.

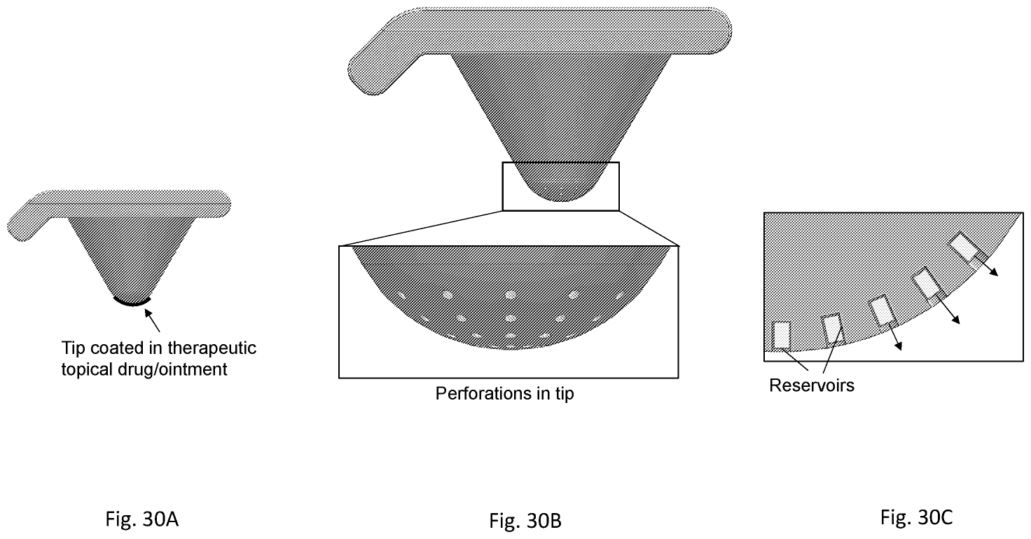

In another illustrative embodiment, the indenter can be designed to deliver a chemical to the user to increase the overall therapeutic effect. For example, the tip of the indenter can be coated with lidocaine, menthol, CBD oil, or any other desired chemical that can assist with muscle pain or tension. In one embodiment, the tip of the indenter can include a plurality of perforations that form cavities (or reservoirs) in the tip. The chemical can be placed into these reservoirs to provide additional volume for storing the chemical (i.e., in addition to the outer surface of the tip) and also for delaying release of the chemical. FIG. 30A depicts a tip of the indenter coated with a therapeutic drug, ointment, or oil in accordance with an illustrative embodiment. FIG. 30B depicts a tip with perforations to accommodate a therapeutic drug, ointment, or oil in accordance with an illustrative embodiment. FIG. 30C depicts how the perforations in the indenter tip act as reservoirs to hold a chemical and release the chemical over time in accordance with an illustrative embodiment.

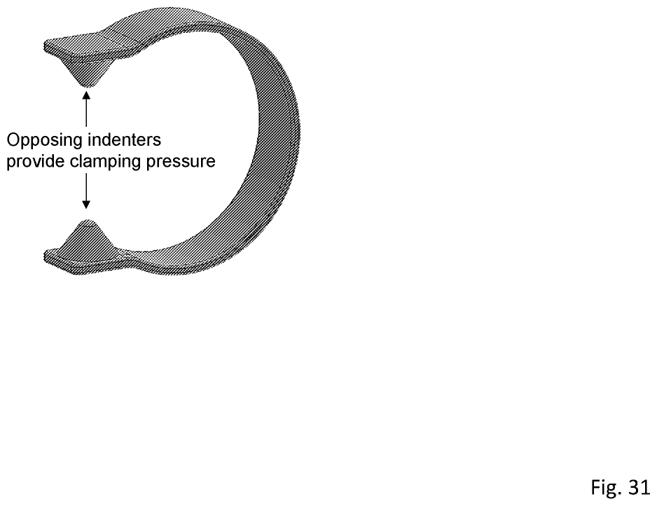

In one embodiment, two or more indenters can be mounted to a clamp that is sized to fit at least partially around an appendage of the user. FIG. 31 depicts a double-indenter clamp in accordance with an illustrative embodiment. As shown, the clamp includes two inward facing indenters that can be used, e.g., on triggers point located on a hand, foot, leg, arm, head, etc. The clamp configuration provides pressure to the indenters from both sides by using a C-shaped structure with an elastic response. In one embodiment, the spring (or elastic) response of the clamp can be tuned to apply more or less pressure. Additionally, different sizes can be used for different body parts. In another embodiment, the clamp can include one or more living hinges to facilitate deformation.

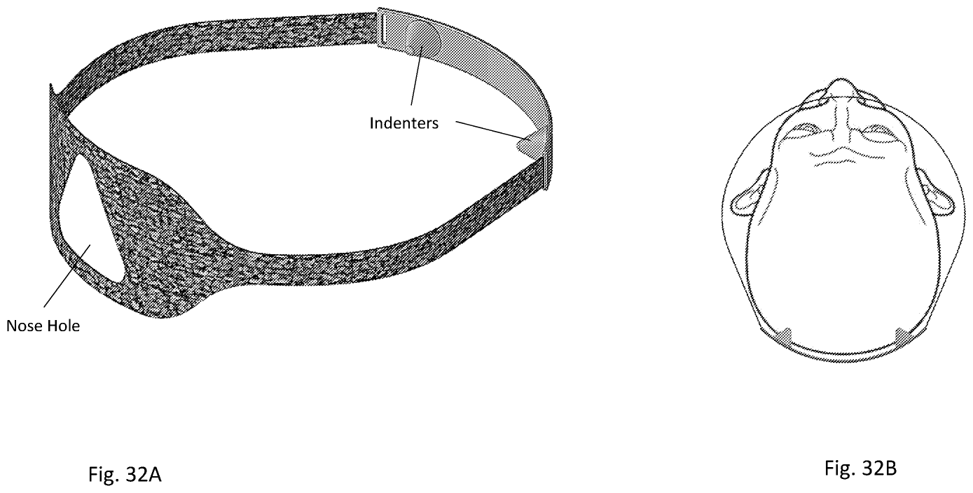

FIG. 32A depicts a face strap with multiple indenters in accordance with an illustrative embodiment. The strap includes a nose hole for being placed over the user's nose, such that the indenters are positioned on the back of the neck and/or head of the user. While 2 indenters are shown, in alternative embodiments, the face strap can include fewer or additional indenters. The strap avoids the user of adhesive/tape near the user's hairline by anchoring to the face, neck, and/or forehead of the user. Such a strap can be used to simultaneously treat multiple trigger points on the user. FIG. 32B is a plan view of the face strap mounted to a head of a user in accordance with an illustrative embodiment.

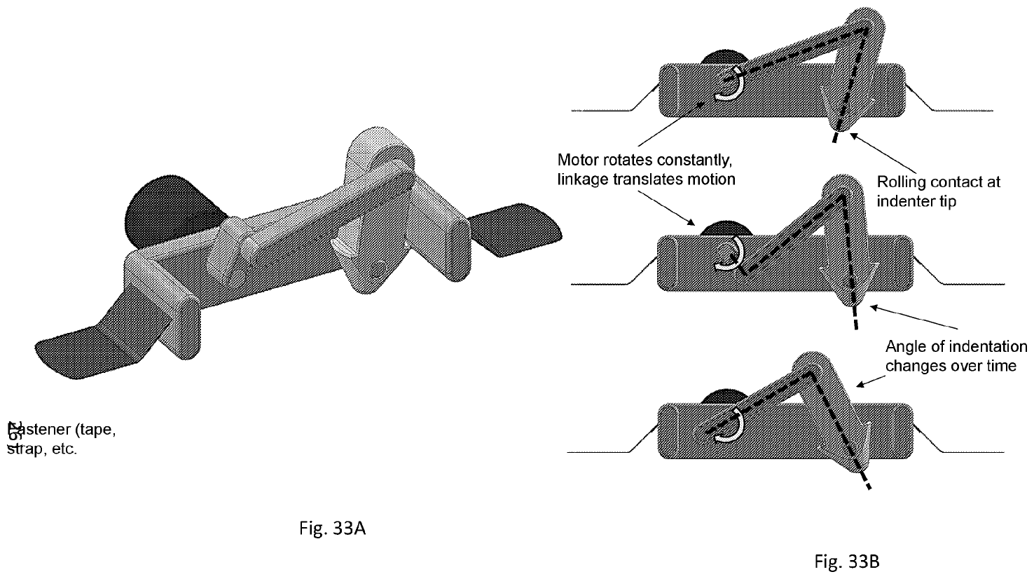

In another embodiment, the indenter can be designed to provide a kneading motion through a four bar linkage or other configuration. FIG. 33A depicts a kneading indenter in accordance with an illustrative embodiment. As shown, the indenter includes a motor that turns an input link, which in turns actuates a rocker link, which in turn moves an indenter that is attached to the rocker link. These components are mounted to a frame of the kneading indenter. The kneading indenter can be mounted using tape and/or a strap as the mount, similar to the other embodiments described herein. The motor of the kneading indenter can be powered by an internal battery, an external source, an energy harvester, etc.

FIG. 33B includes a series of images that depict the motion of the kneading indenter in accordance with an illustrative embodiment. The motor causes the indenter to rock back-and-forth as a result of output from the four bar linkage (or other mechanism). The back-and-forth motion causes the indenter to roll on top of the skin, as opposed to sliding which can cause friction and discomfort. In at least some scenarios, this kneading motion can be more therapeutically beneficial to the user compared to static loading of the indenter.

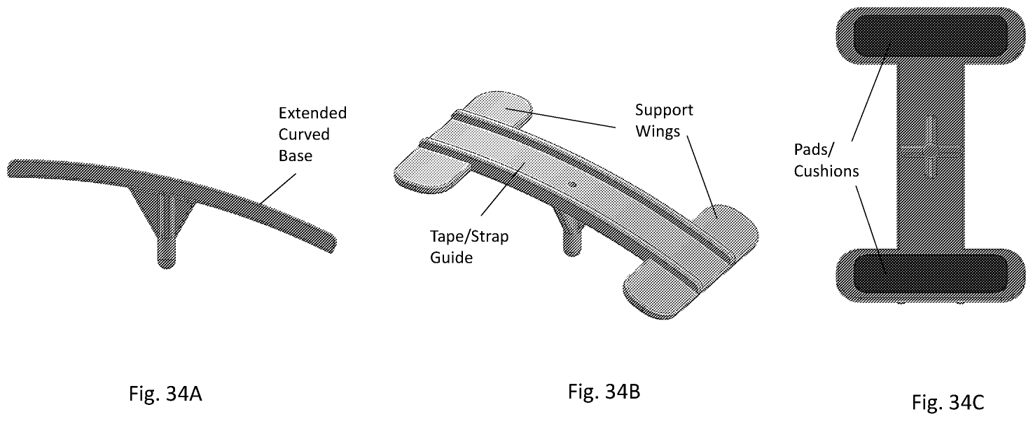

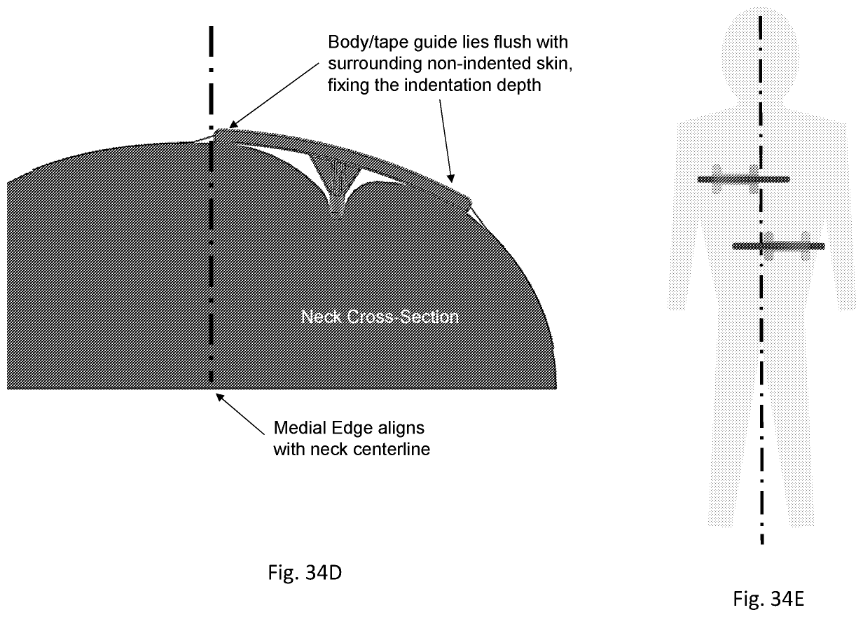

As discussed above, tests were conducted on actual patients and simulations were run to determine optimal positions and angles for the indenter. In one embodiment, an optimal position of the indenter can be at 25-35 degrees lateral to the centerline of the spine. The optimal angle can be 5-15 degrees counter-clockwise from normal vector at the optimal position. Based on these values, different embodiments of the indenter were designed. FIG. 34A depicts an indenter device with an extended base that is curved to match tissue curvature in accordance with an illustrative embodiment. The indenter of the device can be ribbed in one embodiment to provide support and to facilitate injection molding. The indenter can also be conical or pyramidal to provide higher strength and stability. FIG. 34B depicts a top side of an indenter device that includes a base with support wings in accordance with an illustrative embodiment. As shown, the base includes a tape (or strap) guide with edges to ensure that the tape/strap does not slide off of the indenter device. FIG. 34C depicts a bottom side of the indenter device with padding on the support wings of the base in accordance with an illustrative embodiment. FIG. 34D depicts the indenter device with a curved, extended base mounted to a patient in accordance with an illustrative embodiment. FIG. 34E depicts the indenter device having a base with support wings mounted to a patient in various locations along the spine in accordance with an illustrative embodiment.

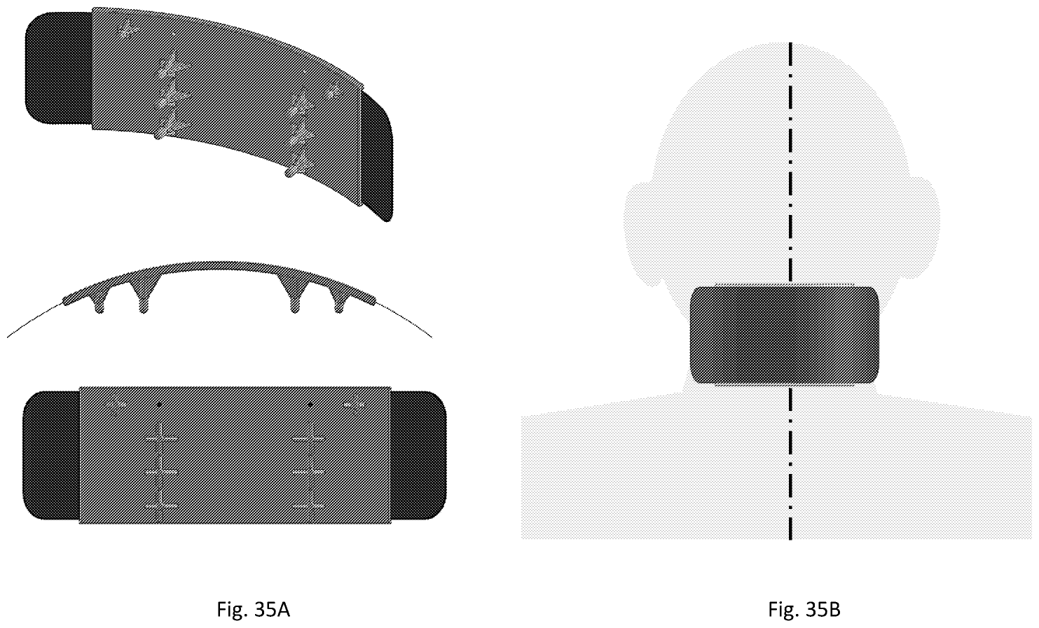

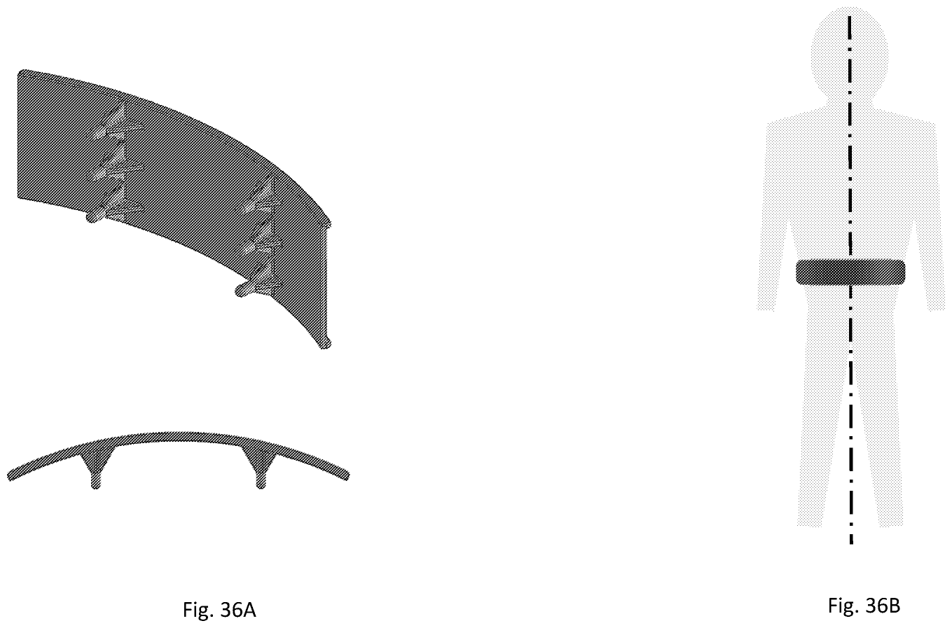

FIG. 35A includes views of an indenter device that includes a plurality of indenters in accordance with an illustrative embodiment. The device of FIG. 35A is designed to target trigger points on the posterior neck of an individual. FIG. 35B depicts the multiple indenter device positioned on the posterior neck of a patient in accordance with an illustrative embodiment. FIG. 36A includes views of an indenter device that includes a plurality of indenters to contact a plurality of trigger points in accordance with an illustrative embodiment. Such a device can be used along the spine of a patient to provide acutherapy. FIG. 36B depicts the multiple indenter device positioned on a lower back of a patient in accordance with an illustrative embodiment.

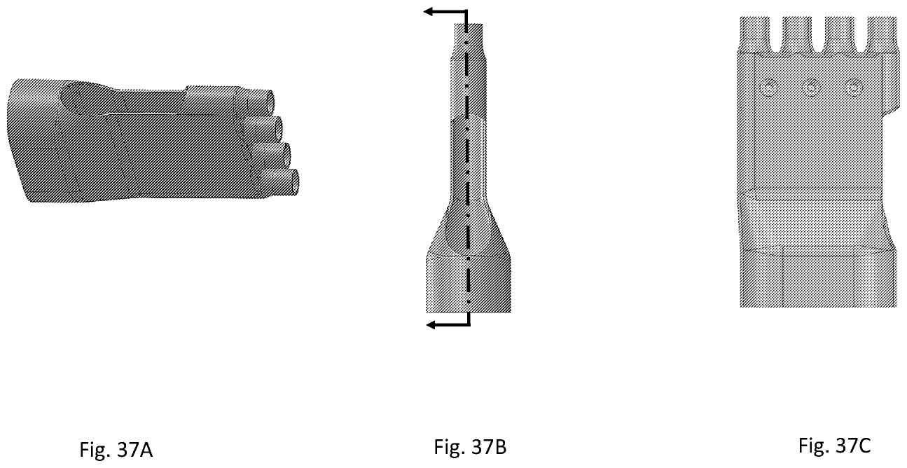

As discussed, the devices described herein can be used on virtually any part of a patient's body where trigger points are present, including the neck, hands, feet, stomach, head, back, arms, legs, etc. FIG. 37A depicts a glove mount with interior indenters for treating a hand in accordance with an illustrative embodiment. FIG. 37B is a side view of the glove mount and includes a sectional line in accordance with an illustrative embodiment. FIG. 37C is a sectional view of the glove mount along the sectional line of FIG. 37B in accordance with an illustrative embodiment. As shown, the interior of the glove mount includes a plurality of indenters that can apply acupressure treatment. While 3 indenters are shown, any number of indenters can be used in alternative embodiments, and the indenters can be positioned anywhere within the glove mount to treat the palm of the hand, the top of the hand, the fingers, etc. In the embodiment shown, the tips of the fingers are not covered by the glove mount. This configuration allows a user to more easily perform tasks (e.g., typing) while wearing the glove mount for treatment.

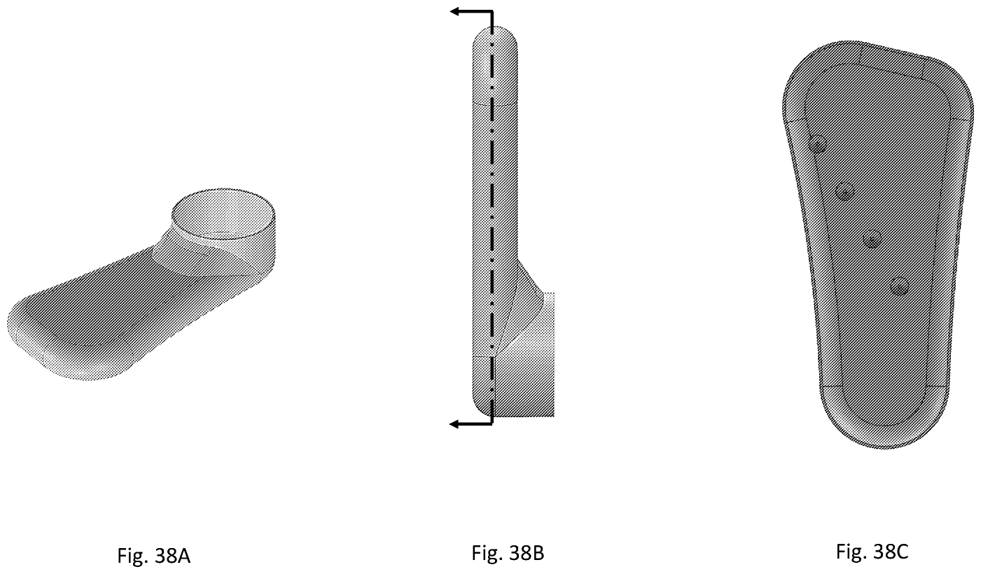

FIG. 38A depicts a foot mount with interior indenters for treating a foot in accordance with an illustrative embodiment. FIG. 38B is a side view of the foot mount and includes a sectional line in accordance with an illustrative embodiment. FIG. 38C is a sectional view of the foot mount along the sectional line of FIG. 38B in accordance with an illustrative embodiment. As shown, the interior of the foot mount includes a plurality of indenters that can apply acupressure treatment. While 4 indenters are shown, any number of indenters can be used in alternative embodiments, and the indenters can be positioned anywhere within the foot mount to treat the sole of the foot, the top of the foot, the toes, the ankle, etc.

The indenters described herein can come in a range of sizes to accommodate different patients. For example, indenter tip diameters can range from 1 mm to 15 mm in one embodiment. Additionally, any of the indenter features described herein (e.g. horizontal vibration, vertical vibration, heat, kneading movement, electrical stimulation, etc.) can be combined and incorporated into any of the indenter designs described herein (e.g., with a pivot arm, with an extended curved base, with wing supports on the base, with a mount guide, with guide arms, with mount handles, with line contact, with point contact, etc.). Additionally, for embodiments with multiple vibrating elements (e.g., horizontal and vertical), the different vibrating elements can operate at the same frequencies or different frequencies, and they can be in phase with one another or out of phase. The indenter can be made from any metal (e.g., copper, stainless steel, aluminum, alloys, etc.), oxide ceramics, and/or plastic/polymer material (e.g., Acetal or Delrin 150).

In one embodiment, the indenter device can include electrical stimulation, vibration (both vertical and horizontal), and heat stimulation. These features can be controlled to switch between cycles of vibration, electrical stimulation, and/or heat to enhance the therapeutic effect. Similarly, the heat (or other features) can be turned on and off in cycles to enhance the therapy. It is also noted that in embodiments with motors, instead of a motor a different driving technique may be used such as magnet-driven motion (e.g., solenoids), fluid pressure-driven motion (e.g., pneumatics), optically-excited materials, shape-memory alloys, etc.

While the primary embodiments described herein are with respect to neck treatment, it is to be understood that the proposed devices are not so limited. The device can be used on the lower back (lumbar), the hands, the fingers, feet, legs, arms, face, head, chest, etc. In such embodiments, the indenters can be incorporated into a belt (e.g., lumbar treatment), a glove (e.g., hand/finger treatment), a sock (e.g., foot treatment), or any other article of clothing. The size of the indenter(s) and the amount of pressure needed will differ between different body parts, and different indenter sizes and/or mounting techniques can be used to treat these various areas. For example, the lumbar spine area would need more pressure than the cervical spine because the muscle groups there are much thicker and bigger. A larger indenter can be used to achieve more pressure. A belt or other strap can similarly be used to achieve more pressure than tape.

Thus, described herein is a treatment device that is a self-applied and maintained external medical device, not involving professional medical supervision or approval. The self-adhering, mobile, acupressure system is applied and attached to the skin and self-monitored and operated by the user for short periods of time. The device can be attached with reusable tape or straps to affix to the skin and which can further accommodate various attachments allowing it to also provide optimal external, surface therapy using, heat/cold, electro-stimulation, vibration, kneading, tapping, massage and external-topical medical delivery of surface chemicals such as creams, gels, pain relievers, external anti-inflammatory medications, ointments, numbing agents, analgesics and anesthetics, and other approved external medications. The purpose of the device is to alleviate muscle spasm, local pain, restricted range of motion and local inflammation and/or irritation of the bones, joints, and soft tissues of the user. The underlying physiological mechanism accomplishing the above is through stimulation and resetting of nerve circuits, fibers and spindles, augmentation of circulation of arterial supply to the local tissue increasing the delivery of oxygen, water and other nutrients, augmentation of venous and lymphatic drainage causing removal of toxic end products of metabolism, lactic acid and other edema fluids, and direct stimulation of bone and soft tissue. There is also a psycho-somatic component to the effect. The above actions reset the nerve reflexes, clean the area of excess or unnecessary toxic chemicals (edema) and substances, and thereby relax the muscles and refresh the tissues, all of which result in diminution of pain and increase in range of motion.

When actually compared to the cost of taking time off of work to visit a doctor and paying for those professional services, the proposed device is drastically less expensive in terms of time and money not to mention that it gives a better result. Finally, as an FDA approved medical device, it would have the extreme competitive advantage that the device would arguably be covered by health care insurance if originally ordered by a physician. Health care carriers, including Medicare would undoubtedly prefer to cover the reimbursement for a service that costs them less and which gives a better result. Insurance coverage for the device would be a very strong effector of sales. Currently, acupressure and electrical stimulus therapy are approved medical procedures and are covered by Medicare and private insurance.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

1. An acupressure device comprising:
a mount that is configured to attach to a patient; and
one or more indenter devices attached to the mount, wherein an indenter device is mounted such that the indenter device is positioned over an acupuncture location of the patient, wherein the indenter device has a base that contacts the mount and a tip that contacts the acupuncture location on the patient.

2. The device of claim 1, wherein the mount comprises one or more pieces of tape.

3. The device of claim 1, wherein the mount comprises an adjustable strap.

4. The device of claim 1, wherein the base of the indenter device includes a mount guide that is sized to receive the mount, wherein the mount guide includes sidewalls that extend from the base to prevent the mount from sliding off of the indenter device.

5. The device of claim 1, wherein the indenter device has a cone shape such that the tip is pointed and causes a point contact at the acupuncture location.

6. The device of claim 1, wherein the indenter device has a triangular prism shape such that the tip forms a line and causes a line contact at the acupuncture location.

7. The device of claim 1, wherein the base of the indenter device includes one or more guide arms that control an angle at which the mount leaves the indenter device.

8. The device of claim 1, wherein the base of the indenter device includes one or more annotations that indicate an optimal angle at which the mount is to leave the indenter device.

9. The device of claim 8, wherein the one or more annotations include a first annotation that indicates a first optimal angle and a second annotation that indicates a second optimal angle, and wherein the first optimal angle differs from the second optimal angle.

10. (canceled)

11. The device of claim 1, wherein the base of the indenter device includes a pivot arm that is designed to contact skin of the patient such that the pivot arm controls an angle of the indenter device relative to the skin of the patient.

12. The device of claim 1, wherein the tip of the indenter device is an electrode that is designed to deliver electrical stimulation to the acupuncture location.

13. The device of claim 1, wherein the indenter device includes a pocket sized to receive a vibratory actuator, wherein the vibratory actuator causes vertical vibration of the tip of the indenter device.

14. The device of claim 13, wherein the pocket is also sized to receive a battery to power the vibratory actuator, and further comprising a power button mounted to the base of the indenter device, wherein the power button turns the vibratory actuator on and off.

15. The device of claim 1, further comprising a heating element mounted within the indenter device, wherein the heating element heats the tip of the indenter device to deliver heat to the acupuncture location.

16. (canceled)

17. The device of claim 1, further comprising a rod and a vibratory actuator mounted to a first end of the rod, wherein a second end of the rod extends through a through hole in the indenter device, and wherein the vibratory actuator causes horizontal vibration of the tip of the indenter device.

18. The device of claim 1, wherein the tip includes a plurality of reservoirs that hold a chemical that is to be delivered to the acupuncture location.

19. The device of claim 1, wherein the base of the indenter device comprises a frame, and further comprising a motor mounted to the frame and a linkage system that is connected to the motor, wherein activation of the motor activates the linkage system to cause the tip to roll across the acupuncture location.

20. The device of claim 1, wherein the base comprises an extended curved base, and wherein the extended curved base includes a pair of support wings that rest on skin of the patient.

21. (canceled)

22. The device of claim 1, wherein the one or more indenters are mounted to a clamp that is sized to fit around a hand or a foot of the patient.

23. The device of claim 1, wherein the mount comprises a face strap, wherein the one or more indenters are mounted to the face strap, and wherein the face strap includes an opening for a nose of the patient.
